(19) United States
(12) Patent Application Publication
(10) Pub. No.: US 2026/0310707 A1
(43) Pub. Date: Oct. 8, 2026

(54) SYSTEMS FOR ADAPTING LANGUAGE MODELS USING USER-INFLUENCED DATA GENERATION

(71) Applicant: Primal Fusion Inc., Kitchener (CA)

(72) Inventors: Peter J. Sweeney, Kitchener (CA); Mathew Whitney Wilson, Kitchener (CA); Jimmy Lin, Kitchener (CA); Harold Scott Smith, Kitchener (CA)

(21) Appl. No.: 19/482,613

(22) PCT Filed: May 10, 2024
(86) PCT No.: PCT/CA2024/050640

§ 371 Date: Nov. 7, 2025

Related U.S. Application Data
(60) Provisional application No. 63/501,641, filed on May 11, 2023.

(51) Int. Cl. G06F 16/335; G06F 16/3329; G06F 40/30

(52) U.S. Cl. CPC G06F 16/335; G06F 16/3329; G06F 40/30

(57) ABSTRACT

There is a method for adapting a language model to represent the intentions of a user. The method includes receiving, from the user, a user input including user data of a request for a language model, analyzing the intentions of the user based on the user input and user data, generating user-influenced data reflective of the analyzed intentions of the user, adapting the language model based on the user-influenced data by at least one adaptation method, and generating an output from the adapted language model.

### TECHNICAL FIELD

The embodiments disclosed herein relate to the field of language models (LMs), and, in particular to systems apparatus, and methods for enhancing LMs with generated, user-influenced data.

### INTRODUCTION

Pretrained LMs, for example large language models (LLMs) such as generative pre-trained transformers (GPT), have problems related to their reliance on training data. LMs can produce content which is incoherent (e.g., off-topic content, inconsistent content, etc.), they can hallucinate false content (e.g., not grounded in reality, not factual, etc.), they can lack common sense, and they can be misaligned with users and/or user intentions. In short, LMs are untrustworthy. Training data often manifest biases or widely held misconceptions that are unfair or unrepresentative of reality. The actual data for accurate training may be unavailable, sensitive or private, limiting the application of LMs in many domains. The ability for LMs to generalize is limited by training data, such that performance across specific or esoteric subjects suffers because training data is sparse. There is currently insufficient data to support the wide generative possibilities of LMs.

At the root, these are data problems: training data, provisioned in the past, does not provide support for new knowledge that individuals seek to create with these systems in the present. LMs lack the data to effectively cater to individuals and their subjective interests, unique perspectives, and personal knowledge. Individuals extend the ever-accelerating boundary of new knowledge that is created in every moment of every interaction, and even the largest LMs cannot keep pace.

A current class of solutions for this problem extends LMs to interact in real-time with external repositories of knowledge. Additional data may be retrieved by a pre-trained LM, using search engines or by interfacing with specialized applications, databases, and reasoners. Although these enhancements increase the amount of data available, these solutions still inherit the same problems because they are based on existing stores of knowledge. Issues of hallucination or lack of common sense may not be solved merely by increasing the magnitude of data. These additional knowledge sources fail to address the boundless potential of generative systems—the new knowledge people wish to create which is not yet available as training data. The full potential of LMs is knowledge creation, not knowledge retrieval. LMs are ill-conceived as improved search engines, and their full potential cannot be realized through better search.

Accordingly, there is a need for systems and methods which enable an LM to create knowledge in real-time which is both accurate and relevant to a user.

### SUMMARY

A method for adapting an LM to represent the intentions of a user is provided. The method includes receiving, from the user, a user input including user data of a request for an LM, analyzing the intentions of the user based on the user input and user data, generating user-influenced data reflective of the analyzed intentions of the user, adapting the LM based on the user-influenced data by at least one adaptation method, and generating an output from the adapted LM.

In an embodiment, analyzing the intentions of the user includes an analysis of at least one of a context, a user prompt, user preferences, and user actions.

In an embodiment, generating user-influenced data includes receiving the user-influenced data at an input translator, translating the user-influenced data by the input translator to a form usable by a semantic engine, receiving the translated user-influenced data at the semantic engine, generating a user-influenced knowledge representation (KR) representative of the translated user-influenced data by the semantic engine, and adapting the LM based on the user-influenced KR.

In an embodiment, the at least one adaptation method includes generating a prompt at a prompt selector from the knowledge representation, and augmenting the prompt at a prompt injector.

In an embodiment, the at least one adaptation method includes fine-tuning a machine learning model using training data derived from the user-influenced knowledge representation.

In an embodiment, the at least one adaptation method includes deriving conditioning variables from the user-influenced knowledge representation, and augmenting the prompt at a prompt injector by applying the conditioning variables to the prompt.

In an embodiment, the at least one adaptation method includes deriving logical constraints from the user-influenced knowledge representation, and applying the logical constraints in a loss function optimizer for a machine learning model.

In an embodiment, the method further includes evaluating a semantic coherence of the output with the analyzed intentions of the user using a semantic evaluator.

In an embodiment, the semantic evaluator is an atomic knowledge representation model (AKRM).

A device for adapting a language model to represent the intentions of a user is provided. The device includes a network interface, a processor, and a non-transitory memory having stored thereon computer executable instructions executable by the processor. The device is configured to receive a user input including user data of a request for a language model. The device is further configured to analyze the intentions of the user based on the user input and user data. The device is further configured to generate user-influenced data reflective of the analyzed intentions of the user. The device is further configured to adapt the language model based on the user-influenced data by at least one adaptation method. The device is further configured to generate an output from the adapted language model.

In an embodiment, analyzing the intentions of the user includes an analysis of at least one of a context, a user prompt, user preferences, and user actions.

In an embodiment, generating user-influenced data includes receiving the user-influenced data at an input translator, translating the user-influenced data by the input translator to a form usable by a semantic engine, receiving the translated user-influenced data at the semantic engine, generating a user-influenced knowledge representation (KR) representative of the translated user-influenced data by the semantic engine, and adapting the LM based on the user-influenced knowledge representation.

In an embodiment, the at least one adaptation method includes generating a prompt at a prompt selector from the knowledge representation, and augmenting the prompt at a prompt injector.

In an embodiment, the at least one adaptation method includes fine-tuning a machine learning model using training data derived from the user-influenced knowledge representation.

In an embodiment, the at least one adaptation method includes deriving conditioning variables from the user-influenced knowledge representation, and augmenting the prompt at a prompt injector by applying the conditioning variables to the prompt.

In an embodiment, the at least one adaptation method includes deriving logical constraints from the user-influenced knowledge representation, and applying the logical constraints in a loss function optimizer for a machine learning model.

In an embodiment, the method further includes evaluating a semantic coherence of the output with the analyzed intentions of the user using a semantic evaluator.

In an embodiment, the semantic evaluator is an atomic knowledge representation model (AKRM).

A system for adapting a language model to represent the intentions of a user is provided. The system includes at least one processor and at least one non-transitory memory storing instructions for execution by the at least one processor to implement a user input device, and a computing engine. The user input device is configured to provide a user input to the computing engine. The computing engine is configured to receive the user input including user data of a request for a language model. The computing engine is further configured to analyze the intentions of the user based on the user input and user data. The computing engine is further configured to generate user-influenced data reflective of the analyzed intentions of the user. The computing engine is further configured to adapt the language model based on the user-influenced data by at least one adaptation method. The computing engine is further configured to generate an output from the adapted language model.

In an embodiment, analyzing the intentions of the user includes an analysis of at least one of a context, a user prompt, user preferences, and user actions.

In an embodiment, generating user-influenced data includes receiving the user-influenced data at an input translator, translating the user-influenced data by the input translator to a form usable by a semantic engine, receiving the translated user-influenced data at the semantic engine, generating a user-influenced knowledge representation (KR) representative of the translated user-influenced data by the semantic engine, and adapting the LM based on the user-influenced knowledge representation.

In an embodiment, the at least one adaptation method includes generating a prompt at a prompt selector from the knowledge representation, and augmenting the prompt at a prompt injector.

In an embodiment, the at least one adaptation method includes fine-tuning a machine learning model using training data derived from the user-influenced knowledge representation.

In an embodiment, the at least one adaptation method includes deriving conditioning variables from the user-influenced knowledge representation, and augmenting the prompt at a prompt injector by applying the conditioning variables to the prompt.

In an embodiment, the at least one adaptation method includes deriving logical constraints from the user-influenced knowledge representation, and applying the logical constraints in a loss function optimizer for a machine learning model.

In an embodiment, the method further includes evaluating a semantic coherence of the output with the analyzed intentions of the user using a semantic evaluator.

In an embodiment, the semantic evaluator is an atomic knowledge representation model (AKRM).

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a box diagram of various adaptation methods which can be used to adapt a pre-trained LM;

FIG. 2A is an overview of a system for enhancing a LM, according to an embodiment;

FIG. 2B is a flow diagram of a method of enhancing a LM according to an embodiment;

FIG. 3 is a box diagram of various user interfaces for receiving and adapting user input for the systems and method herein;

FIG. 4 is an overview of a system for input translation to be used during LM enhancement, according to an embodiment;

FIG. 5 is an overview of a system for engineering prompts to be used during LM enhancement, according to an embodiment;

FIG. 6 is an overview of a system for data engineering to be used during LM enhancement according to an embodiment;

FIG. 7 is an overview of a method of generating data for enhancing an LM, according to an embodiment;

FIG. 8 is an overview of a method of generating data for enhancing an LM, according to an embodiment;

FIG. 9 is an overview of a method of using analyzed user intentions to enhance an LM, according to an embodiment;

FIG. 10A is a box diagram of a system for augmenting a prompt with a user-influenced KR to enhance an LM, according to an embodiment;

FIG. 10B is a box diagram of a system for augmenting a prompt with a user-influenced KR to enhance an LM, including a mediator, according to an embodiment;

FIG. 11A is a box diagram of a system for using a user-influenced KR and an LM to label input data for a machine learning (ML) classifier, according to an embodiment;

FIG. 11B is a box diagram of a system for using a user-influenced KR and an LM to label input data for an ML classifier, including a mediator, according to an embodiment;

FIG. 12 is a box diagram of a system for using a user-influenced KR to develop a semantic evaluator for an LM, according to an embodiment;

FIG. 13 is a box diagram of a system for using an atomic knowledge representation model (AKRM) to evaluate candidate output from an LM, according to an embodiment;

FIG. 14 is a flow diagram of a method for using an AKRM as a source of logical constraints when training a probe for assessing the semantic consistency latent knowledge of an LM, according to an embodiment;

FIG. 15 is a block diagram of a computing device for system and methods of enhancing LMs;

FIG. 16 is an overview of a system for managing conditioning variables derived from prompts during LM enhancement, according to an embodiment;

FIG. 17 is an illustration of the AKRM for coherent semantics, according to various embodiments; and

FIG. 18 is an overview of a system for self-training an LM using knowledge generation rules to select semantically coherent concepts, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

It is to be understood, that one or more systems described herein are implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The embodiments and implementations described below provide for at least one non-transitory computer readable storage medium storing processor-executable instructions that, when executed by at least one processor, cause the at least one processor to enhance an LM, based on input received at the same or a different at least one processor from a user and on user data representative of the user's intentions.

Various components of the systems described herein may be encoded as non-transitory computer-readable data structures, for example KRs.

As described above, LMs are not able to reliably provide content which is coherent, non-hallucinatory, and relevant to a user. While current solutions of causing the LM to search for and acquire supplemental knowledge from further knowledge repositories may appear to improve content output, the aforementioned problems are often not solved due to insufficient availability of historical data. These solutions merely allow for greater knowledge retrieval but not for knowledge creation.

The solution to the problem is not more data, as the data simply does not exist, and will not exist until people create it, interactively, with the LM. LMs receive explanations of how to create data in order to work collaboratively and creatively with individuals.

The solution provided herein enables evaluation and recognition of a good and accurate result upon generation by an LM, within the context of each individual user.

The solutions provided herein enhance the generative abilities of LMs, based on analyses of directly or indirectly acquired user data and/or user intentions, such that they are less apt to produce outputs that are misaligned with users.

There are many techniques which can be used to improve the performance of an LM such as changes to loss functions, regularizations, hyperparameter tuning, as well as various training strategies, including reinforcement learning, supervised learning, curriculum learning, and so forth.

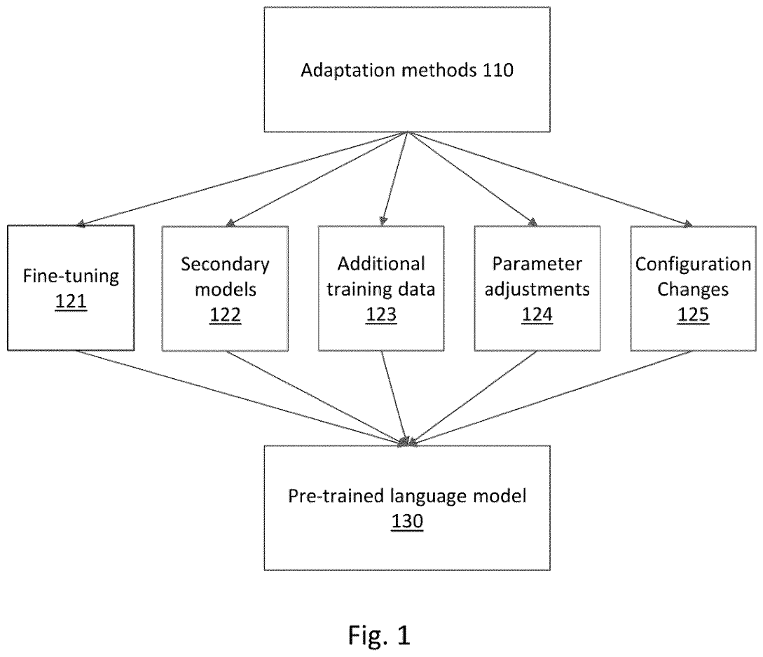

FIG. 1 is a box diagram showing several examples of different types of adaptations which can be effected through adaptation methods 110 to adapt or enhance an LM. The adaptation types, which can be applied to an LM, in FIG. 1 are fine-tuning 121, secondary models 122, additional training data 123, configuration parameter adjustments 124, and configuration changes 125. This list is not exhaustive and many other LM adaptations can occur.

Herein these various adaptation types are deployed following adaptation methods which seek to enhance an LM based on an analysis of the intentions of a user. The coherence of the resulting adapted LM to the intentions of the user is measured to determine how successful the adaptation was at achieving a desired output. By adapting the LM to be more coherent to analyzed user intentions instead of by merely increasing the amount of data which trains the LM, the LM is not only more aligned with the user, but also incoherent, hallucinated, and nonsensical outputs are reduced.

Fine-tuning 121 the LM may involve data engineering to provision additional data specific to the desired task for further training.

Secondary models 122 may involve employing secondary models in conjunction with LMs to perform task-specific evaluations.

Additional training data 123 may involve generating or otherwise acquiring further training data to train the LM.

Prompt engineering 124 may involve manipulating the parameters or contents of inputs.

Configuration changes 125 may involve manipulating the configuration of LMs by modifying parameters such as temperature or token constraints.

Others modify their internal mechanics, such as incorporating new constraints into loss function optimizations.

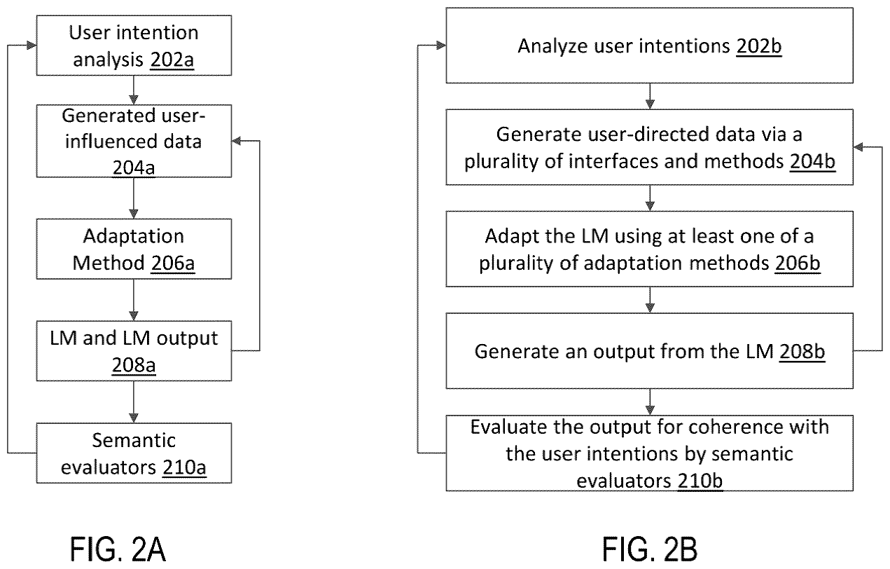

To illustrate the flexibility LMs provide, the functional components, briefly discussed above and more thoroughly discussed below in FIGS. 2-9, will be deployed and redeployed in a variety of ways in the specific embodiments that follow.

Herein, measures of “coherence” or “congruence” of various aspects with other aspects are discussed. Both terms are meant as a measure of the similarity between two things and may be used interchangeably or separately depending on the embodiment being discussed. In general, the terms are measuring the alignment of an output of the system (which could be an intermediary output or a final output) with the intent of a user as determined by analysis of user-derived data.

Referring to FIGS. 2A and 2B, illustrated therein are box diagrams of an overview of a system (2A) and a method (2B) for enhancing LMs to align with users, according to an embodiment.

The functional elements of FIG. 2A are an analysis of user intentions 202a, generated user-influenced data 204a, at least one adaptation method 206a, an adapted LM and LM output 208a, and semantic evaluators 210a.

FIG. 2B includes analyzing user intentions 202b, generating user-influenced data via a plurality of interfaces and methods 204b, adapting an LM using the user-influenced data 206b, generating an output from the adapted LM 208b, and evaluating the adapted LM and/or the LM output against the user intentions by semantic evaluators 210b.

The method, in which these functional elements are employed, begins with an analysis 202a of the intentions of users of the LM 208a.

In some embodiments, the analysis 202a may be initiated following active input of data from a user into an application or computing engine. That is, a user may have a specific query or desired output which they are actively pursuing and the intentions of the user may be analyzed in the context of the specific query or desired output.

In other embodiments, the analysis of intentions may be initiated by implicit input from the user acquired by monitoring the actions and preferences of a user on a device or multiple devices and within an application or multiple applications. That is, the user may not be specifically requesting an output but an output may be generated and shown, or otherwise provided, to the user based on their activity. In yet other embodiments, the user may be actively requesting a specific output but the output may be generated from historical input from the user which shows the user's intentions.

Herein, the input from the user which initiates the analysis of intentions (whether it is explicit/active or implicit/passive) is referred to as the “user request”. The request may take any form which triggers an output from the system.

In all embodiments, the request or query from the user is augmented by the system using knowledge of the user's intentions. That is, the system uses user-derived context to better understand the intended output of the request provided by the user by analyzing the user's intentions. Herein “understand” is meant to convey that the ability of the system to process and interpret information from and about the user is improved.

The user intention analysis 202a may occur after a user request, before a user request, or a user may trigger an analysis after they determine an output they received for a request is not sufficient. The user intention analysis 202a may be continuously occurring as new user information is acquired or may have been initiated before the user entered a request and stored for future requests wherein the user intention analysis is applied as is when a request occurs. The user intention analysis 202a may have been initiated before a request but is further expanded upon for the context of the current request. The user intention analysis 202a may only begin when a request is received and therein the analysis may be a broad analysis or may be specific to the context of the request. Initiating the analysis before a request or as a broad analysis may save time, but initiating the analysis specifically for the context of the request may ensure more accurate results. The user intention analysis 202a may be a background process which occurs automatically or may be a process which a user actively initiates.

The data used for user intention analysis may come from user behavior data, search query data, form inputs and other textual data, collaborative data, user profile data, user personas, user context data, etc. In some embodiments, the data from these different sources may be collected and integrated into a user model.

Regardless of the method of input, user-influenced data may be generated through an analysis of the user's intention. The user request may be augmented with user-influenced data to provide an input to the adaptation method. The input comprises generated user-influenced data 204a. The user intention analysis 202a outputs an analysis of what the user actually wants to achieve based on the request (active or passive) from the user and the intentions of the user. The user-influenced data 204a represents this user intention. The generated user-influenced data may be semantic, encoding the meaning of the intention, and in the form of any formats or vocabularies which may be used to represent semantic data.

In some embodiments, this user-influenced data may be generated by the LM, as discussed below. In other embodiments the data may be generated elsewhere.

The user-influenced data is applied to the LM 208a through adaptation methods 206a, discussed herein in various embodiments, to vary the output of the LM. Semantic evaluators 210a are then used to evaluate whether the output from the LM coheres with the initial analyzed user intentions. If the LM does not cohere with the analyzed user intentions, the method may return to analysis of user intentions and a user may be prompted to input further data regarding their intentions or an application may acquire broader data regarding the user.

The adaptation method 206a may enhance the LM using any of the adaptation types discussed in FIG. 1 or any other adaptation type which is achievable and appropriate. The adaptation types may be chosen, either automatically or manually, based on the analysis of user intentions 202a. The adaptation method 206a applies the user-influenced data to the LM to adapt an appropriate aspect of the LM to provide outputs which are aligned with the user intentions.

In other embodiments of the system, user-influenced data may be both an input to the adaptation method and a product of the adaptation method. That is, the adaptation method itself may receive user-influenced data as an input, for example, in the form of a prompt or query which has been adapted to fit the user intentions, and may generate further user-influenced data, for example a KR, which is applied during the process. In the simplest embodiment the user-influenced data encompasses data which is applied directly to an LM which outputs a result which is then compared to the user intentions for coherence. While in a more complex embodiment the user-influenced data may comprise any or all data which is generated between analysis of user intentions and semantic evaluation of an output, excluding the output, wherein the generation of said data has been influenced by data derived from the user. In embodiments where user-influenced data is generated during adaptation methods, user-influenced data generation and the adaptation method may, at least partially, occur at the same time.

The embodiments that follow implement several methods of enhancing LMs (for example those shown in FIG. 1) to illustrate architectural flexibility. The embodiments include other such variant interfaces, implementations, and integrations, as well as opportunities to combine these various embodiments in new ways.

A LM is used to predict a sequence of tokens comprising words and symbols. There are a wide variety of architectures used for LMs including transformers, convolutional neural networks (CNNs), long-short term memory (LSTM) models, recurrent neural networks (RNNs), and many probabilistic, statistical, and rule-based models. Herein, a “language model” or “LM” is a black box that takes an input as text and predicts a new sequence of text. The input may be text or may be other media such as pictures or videos. Any form of input which may ultimately be input as text is contemplated as input herein. Specific pertinent interfaces of LMs, such as training data, prompts, and loss function optimizers, will be discussed in more detail in the context of each specific interface and embodiment.

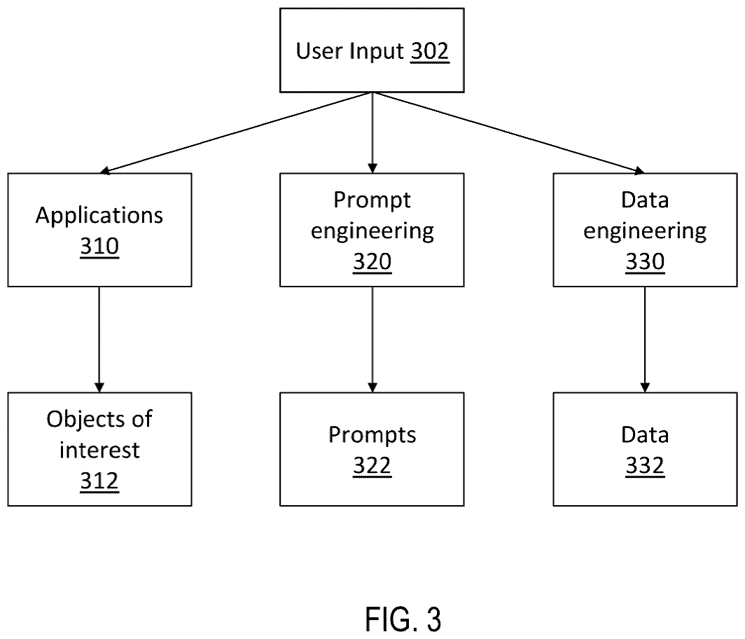

Referring to FIG. 3, therein is shown a box diagram of various user interfaces which may receive input from a user.

FIG. 3 presents the main user interfaces. People who use LMs and other computing engines are called users. These people hold many different roles, including, but not limited to, data scientists, machine learning engineers, prompt engineers, application developers, academics, knowledge workers, and content creators, producers, and consumers.

Users may interact with the system through user input into applications to identify objects of interest (such as documents, images, or videos), or user input within methods of prompt engineering or data engineering, as discussed in the embodiments that follow. The user may interact with a single interface or multiple interfaces. That is, for example, the user may only choose objects of interest or only create a prompt, or the user may both choose objects of interest and create a prompt.

F FIG. 3 represents possible interfaces and pathways which can be used in the first two steps of the method of FIG. 2B: analyzing user intentions and generating user-influenced data. The outputs of objects of interest 312, prompts 322, and data 332 are examples of user-influenced data which are not intended to be exhaustive.

Applications 310 may include any program or application which allows the user to choose objects of interest 312 by user input 302. The objects of interest are then analyzed as discussed above for user intentions. User input 302 may be an active input from a user requesting an output or could be a passive input from a user derived through indirect methods such as their browsing activity or other contextual or environmental indicators.

Prompt engineering 320 are methods of generating an appropriate prompt or prompts, i.e., inputs to a model, to achieve the desired output from the model. Prompt engineering 312 allows a user to create prompts 322 through user input 302.

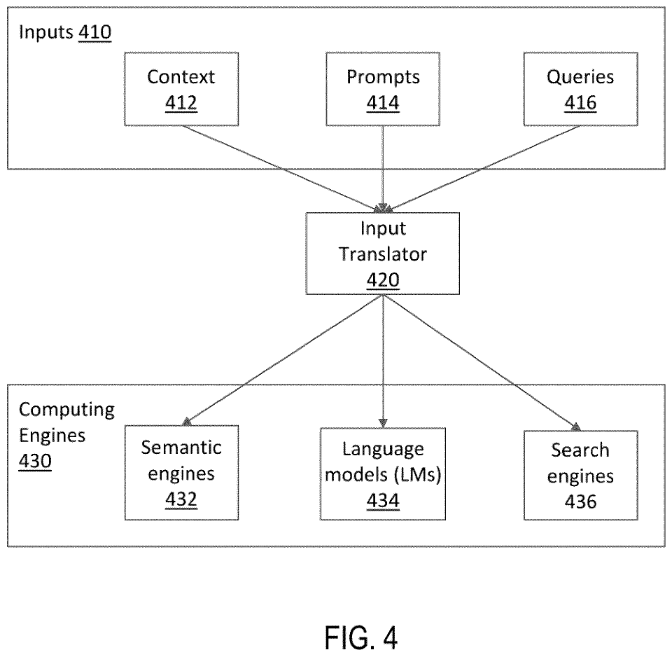

Data engineering 330 are methods of collecting, storing, processing, and analyzing data. Here, data engineering provides a foundation for evaluating coherence. FIG. 4 is a box diagram of input translation of the various possible inputs from users. FIG. 3 showed the various ways in which a user can interact with the interfaces to input data which demonstrates their intentions or to request an output from an LM. FIG. 4 shows the processing of the inputs to enable interoperation of various inputs with various downstream computing engines.

Any computing engine, including reasoners, search engines, semantic engines, LMs or other ML models may interoperate via natural language inputs. These inputs may be coupled, such that a single user input is directed to multiple computing engines. However, the user intention implied differs based on the computing engine used, and the form of each input will vary. Search engines are queried; semantic engines are contextualized; LMs are prompted; and so forth. Where singular inputs are distributed across multiple tools, there may be a translation of user inputs to align with each downstream tool. Here, this functionality is called an “input translator”, within the class of data transformation tools more generally, although the function may be described as extraction or as translation.

FIG. 4 includes inputs 410, including context 412, prompts 414, and queries 416 which are then translated through an input translator 420 which puts the inputs into a form which is aligned with and usable by the various computing engines 430, including semantic engines 432, LMs 434, and search engines 436.

FIG. 4 represents the second and third steps of the method of FIG. 2B. The inputs 410 comprise examples of user-influenced data. The input translator 420 and the computing engines 430 may be components of various adaptation methods used within the systems and methods described herein.

For example, a user input 410 may be in the form of a query 416 which can be used in that form by a search engine but not by a semantic engine. Therefore, the query 416 may be translated into a context form to also be used by the semantic engine 432. In some embodiments, a single input 410 may be translated into multiple forms to be used with multiple computing engines. In some embodiments, there may be multiple forms of input to be aggregated and translated into forms usable by the various computing engines. In some embodiments, the input 410 may be in a form that is not context 412, prompt 414, or query 416 and may be translated into one of those forms.

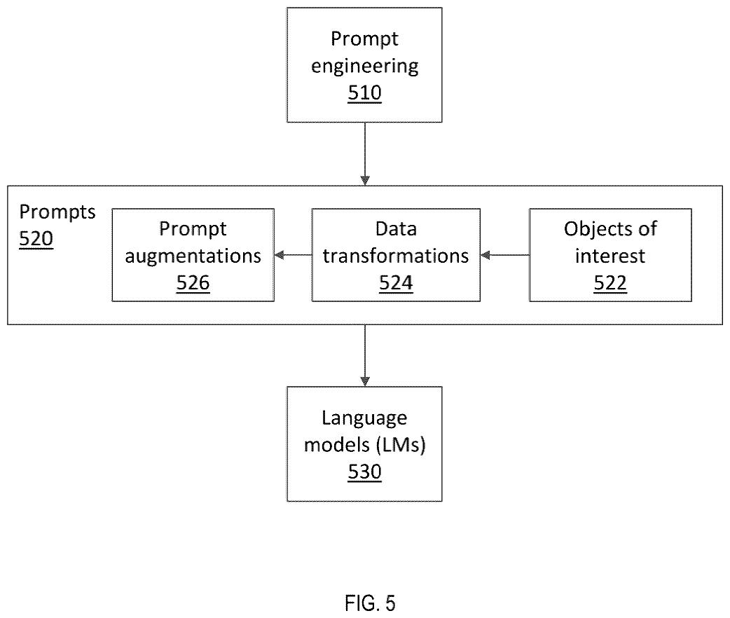

As discussed above, the inputs users provide to LMs are called prompts. Generally, the activity of augmenting the performance of an LM through prompts is called prompt engineering (discussed below and shown in FIG. 5). Evaluations of the coherence of prompts with the desires of users may motivate programs of prompt engineering.

Prompts are composed of text, often chained in sequences. Prompts provide background knowledge, constraints, and context for the LMs. Prompts encapsulate the desired direction or intentionality of inference for the LMs, often in the form of instructions and sometimes with accompanying examples. Prompts may include metadata or labels associated with objects of interest (such documents, images, or videos), or the expression of abstract concepts (such as semantics, sentiment, tone, or style).

FIG. 5 is a box diagram overview of a method of engineering prompts to be used to enhance an LM.

As discussed above, prompt engineering is a method of generating an appropriate prompt or prompts to achieve the desired output from the model. As shown in FIG. 3 prompt engineering is one of the possible inputs through a prompt engineering interface that a user may input to generate an output from an LM. As shown in FIG. 4, other forms of input may be translated by an input translator to create a prompt for use with an LM.

In FIG. 5, prompt engineering 510 is performed to create a prompt 520 (or prompts) for the LM 530. The prompt engineering may be direct prompt engineering by a user or may be indirect prompt engineering through a translator. Regardless of the origin of the prompt(s), an analysis of the prompt(s) for coherence with the desires of the user may determine that the prompt is sufficient and the prompt may be used as is to prompt the LM 530.

When an analysis of coherence of prompt 520 for the desires of the user determines that the prompt 520 is not sufficient, the prompt may be augmented or extended. Prompts may be augmented or extended through secondary processes, often via data transformations. These processes are called prompt augmentations or prompt injections.

In the embodiment of FIG. 5, objects of interest 522, collected from the user undergo data transformation 524 for prompt augmentation 526 of the prompt to a form which is sufficient for the user. After prompt augmentation the prompt 520 may undergo further analysis of coherence and multiple rounds of augmentation may occur as necessary.

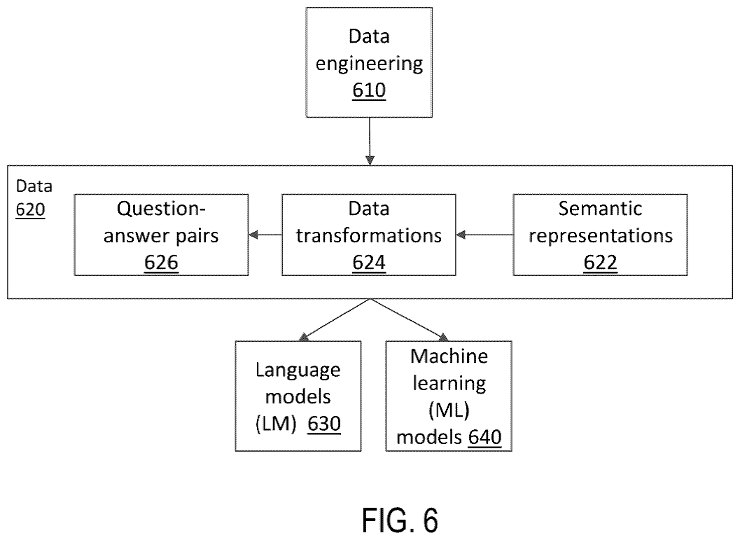

Analogously, as shown in FIG. 6, data may be used to train, validate, evaluate, and explain LMs. Adapting an LM through data is called data engineering as discussed above for FIG. 3.

One class of data is semantic data. Semantic representations, data expressing the meanings of words and statements, provide a foundation for evaluating coherence of the LM to user intentions. Semantic representations may be constructed as graphical data structures, with nodes representing concepts, edges representing relationships between concepts, and various properties associated with these nodes and edges to enhance their expressivity. There are many other semantic representations, including so-called black box models derived from ML. For the purposes of this disclosure, a semantic representation provides a computer with a model of the underlying meaning of natural language.

One common class of training data is questions and answers. Other classes of data may be reformulated (or transformed) as question-answer (QA) pairs. The semantic representations are transformed into question-answer pairs. For example, the assertion, <car> ISA <vehicle>, may be reformulated as a question-answer pair using a simple data transformation: ISA (car, vehicle)={True/False}. In this way, semantically transformed QA pairs may be used with binary ML classifiers as semantic evaluators.

FIG. 6 is a box diagram overview of a method of data engineering to be used to enhance an LM.

In FIG. 6, data engineering 510 is performed to generate data 620 which can be used by LMs 630 as well as other ML models 640. The data 620 which is used as an input into the LM 630 or ML model 640 may be directly entered into the models from data engineering or may first undergo data transformation 624 from semantic representations 622 to question-answer pairs 626.

In other embodiments, the data 620 from the data engineering 610 may undergo other forms of data transformation and be entered into the models in forms other than question-answer pairs.

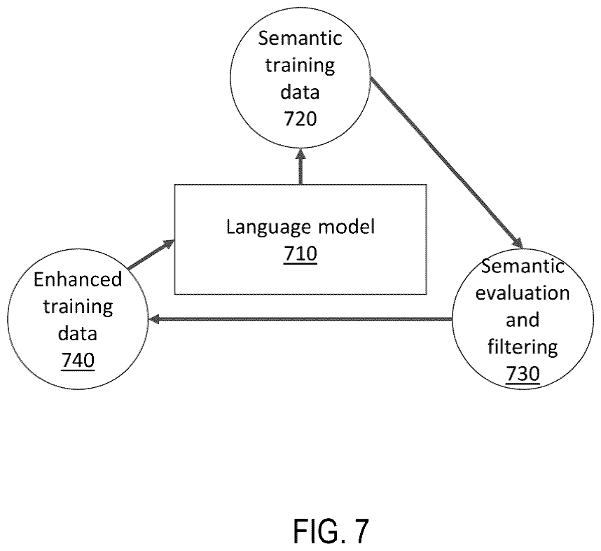

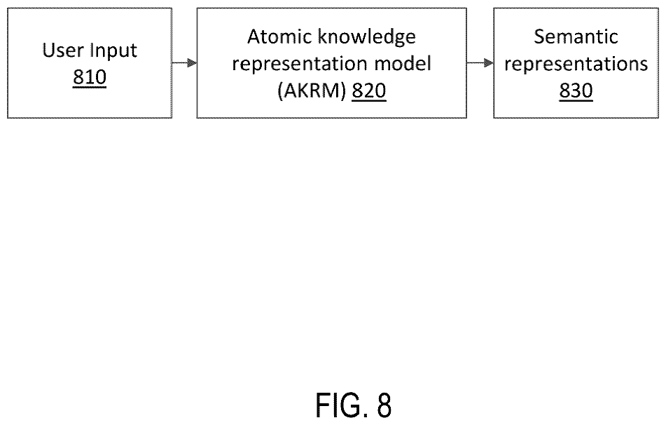

FIGS. 7 and 8 are overviews of methods of generating data for adapting an LM using semantic engines, according to an embodiment. As discussed above, user-influenced data may be generated from the LM which is being adapted.

An automated process of generating data, whether through methods of data induction, the aggregation or integration of data sets, or the extraction of data from KRs, is known as data generation. Herein, the various generators of semantic data are referred to as “semantic engines.”

The data generation discussed in FIGS. 7 and 8 is not the same as the data engineering discussed above. The semantic engines discussed in FIGS. 7 and 8 are the same as the semantic engines 432 of FIG. 4. The semantic engine receives input from the user either directly or through the input translator which the semantic engine then uses to generate and alter data from the LM which is then returned to the LM as training data which adapts the LM to the intentions of the user.

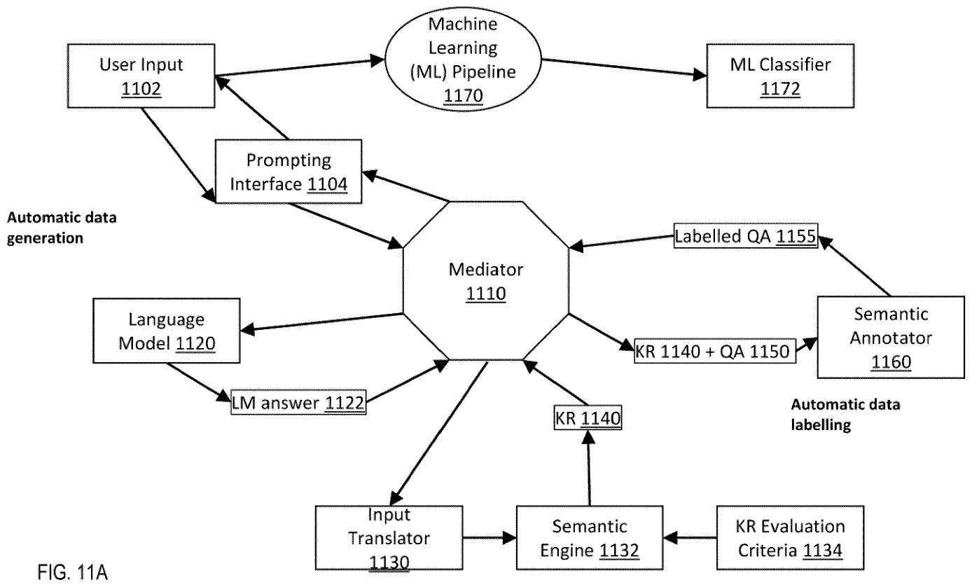

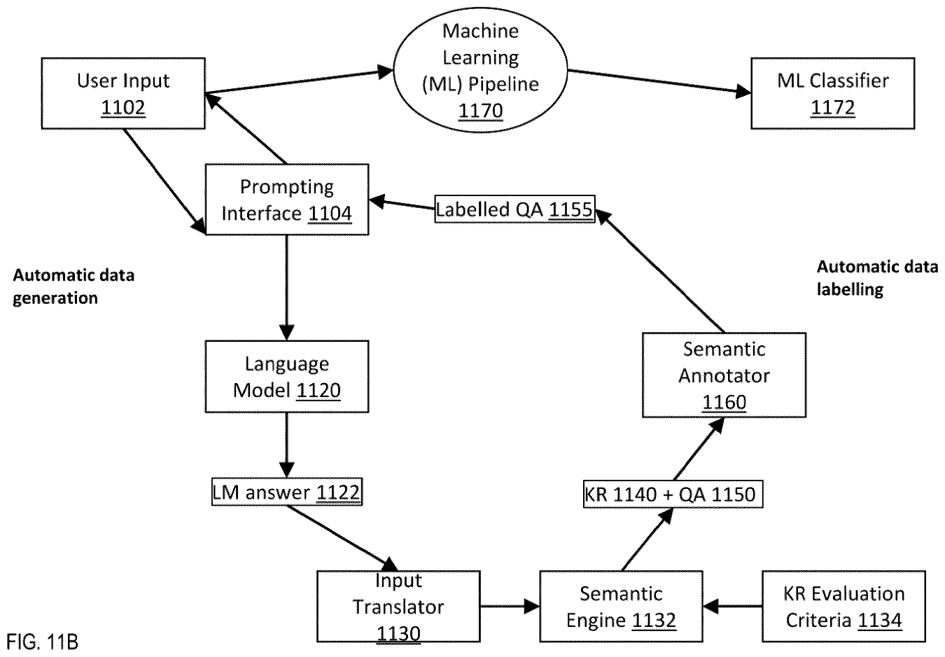

LMs are themselves important engines of data generation, including semantic engines. In LM data generation, candidate training data is generated from the LM, the candidate training data is selected (filtered) using evaluative criteria, and the filtered training data is used for training a secondary model (e.g., a ML model, see FIG. 11 below) or retraining the LM.

In FIG. 7, semantic training data 720 is derived from the LM 710 by a semantic engine which has received an input from the user representing user intentions (as discussed above in FIG. 4). The semantic training data is evaluated and filtered by the semantic engine using the input from the user to generate user-influenced enhanced training data which is used as an input for adaptive retraining of the LM.

FIG. 8 is a box diagram of an overview of how semantic evaluators are used to determine coherence of the adapted LM with the intentions of a user within the systems and method described herein.

An LM is deemed coherent if the output coheres, directly or indirectly, with a semantic representation of the user's intentions or expectations for the output. Various methods may be applied to determine the level of coherence, such as measures of semantic similarity. This question may be evaluated directly with respect to users' inputs, or indirectly through surrogate models, agents, applications, or data working on behalf of the user. Herein, evaluative tools are referred to as evaluators, and evaluators of semantic coherence as semantic evaluators.

As shown in FIG. 8, semantic engines may also be based on other models. FIG. 8 shows a method of generating data in the form of semantic representations. An AKRM 820 generates semantic representations 830 for a given user context which is derived from user input 810.

The AKRMs discussed herein may be similar to those described in U.S. Pat. No. 9,177,248 and U.S. patent Ser. No. 17/713,096, both incorporated by reference herein.

AKRMs are based on the compositionality of semantics, enforcing constraints on how concepts may be combined and organized in relational hierarchies. In this embodiment, the AKRM 820 draws context from the user input 810 provided by a user, which may include prompts, queries, or any other objects of interest that may be described using text, such as web pages, images, or videos. The user input 810 may be translated by an input translator to be usable as context for the AKRM 820. An AKRM takes context as input and returns a semantic representation that expresses the meaning of that context.

The semantic representations 830 could be used as input data in FIG. 6 wherein semantic representation 622 are transformed to question-answer pairs to be used in LMs and ML models.

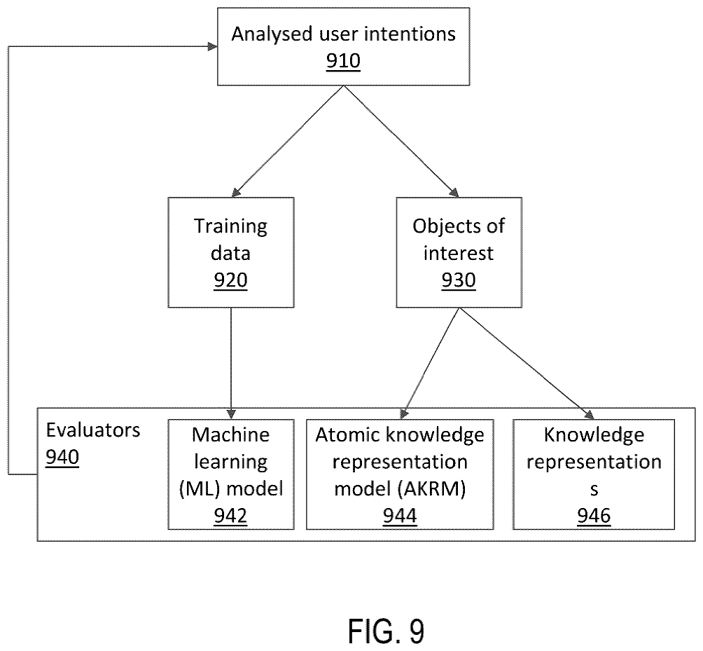

FIG. 9 includes analyzed user intentions 910 which are used to generate either training data 920 or objects of interest (prompts, queries, etc.) which are used as input to adaptively train an LM based on the intentions of the user. After the LM has been adapted based on the input(s) at least one evaluator 940 is used to measure the coherence of any output of the adapted LM to the analyzed user intentions 910. The evaluators may include a ML model 942, an AKRM 944, and/or a KR 946.

ML models may be deployed as evaluators for adapting an LM. These may be called probes. For example, ML model 944 may be used to classify the validity or coherence of an adapted LM output with respect to a user input.

Classification may be used to evaluate question-answer (QA) pairs derived from semantic representations. Here, the ML model is referred to as a classifier. The model itself may be implemented in many different ways, such as the use of regression techniques for classification, and the data provisioned may be used for many training, evaluation, or explicative purposes within the development process. These methods may be used to train any ML model for any task by annotating the task-specific data with KRs generated from a common context with these objects. Examples of these objects include question-answer pairs or the descriptions of images and videos. The use of KRs as metadata for data augmentation.

One direct evaluation of semantic coherence uses AKRM 944. Other KRs that indirectly express users' intentions may be used for semantic evaluations. In FIG. 8, AKRM 944 or KR 946 may be generated based on the output of the LM and compared to the analyzed user intentions 910 to measure coherence.

For example, a browser that derives a KR, such as KR 946, for a web page may represent the intention implied by the browsing activity. A KR derived from a user's past interactions with an application or content may similarly imply their present intentions. An authoritative source, such as the rules or laws that govern a professional practice, or the consensus of a body of experts expressed in academic literature, may imply the intentions of users within these communities. There are many such KRs that may be generated or prepared to represent the intentions of a user.

The semantic evaluations discussed here may be applied as pre-training to annotate training data; semantic evaluations may be used as goals for post-training reinforcement learning; training data may be prioritized based on these semantic evaluations as a form of curriculum learning; the prompting provided by users may be reformulated as pre-training under supervised learning; and so forth. The embodiments included may be applied across a broad swath of these techniques, to the goal of improving the alignment or coherence of LMs with their users.

The functional components discussed above will be deployed and redeployed in a variety of ways in specific implementations that follow.

Augmenting a Prompt with a User-Influenced Knowledge Representation (KR) to Enhance a Language Model (LM)

In this adaptation method implementation, a prompt is augmented with a KR to enhance an LM. A user input, representing user intentions, is received through a prompting interface and a semantic engine uses the user input to create a KR which is then used to augment the prompt for use as an input to the LM to adapt the LM to the user input.

A prompt provides instructions to an LM on what output to create. The evaluation of the output depends on the fidelity of the input. An output will only be evaluated as coherent with the intentions of the user if the foundation for evaluation derived from the prompt (or surrogate inputs) supports the evaluation.

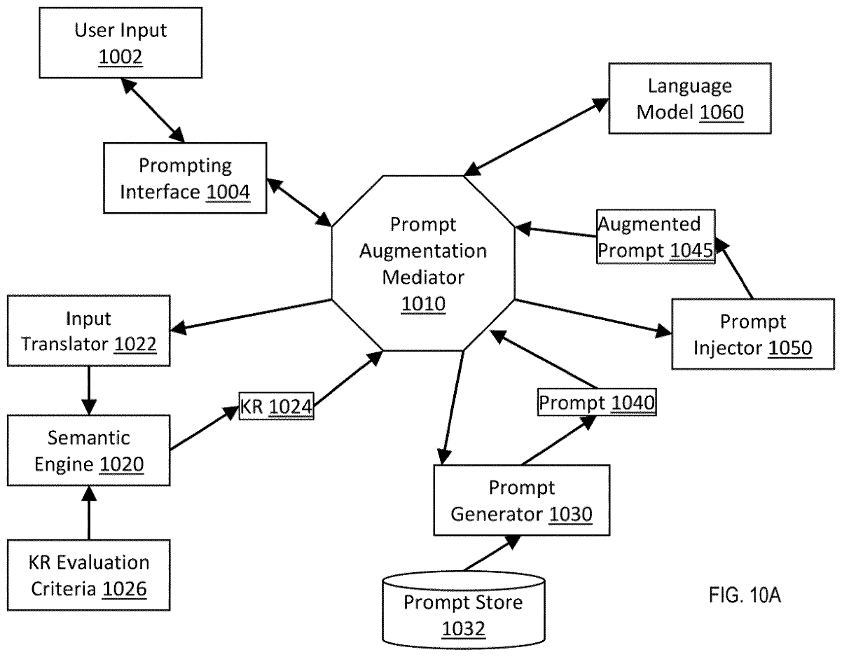

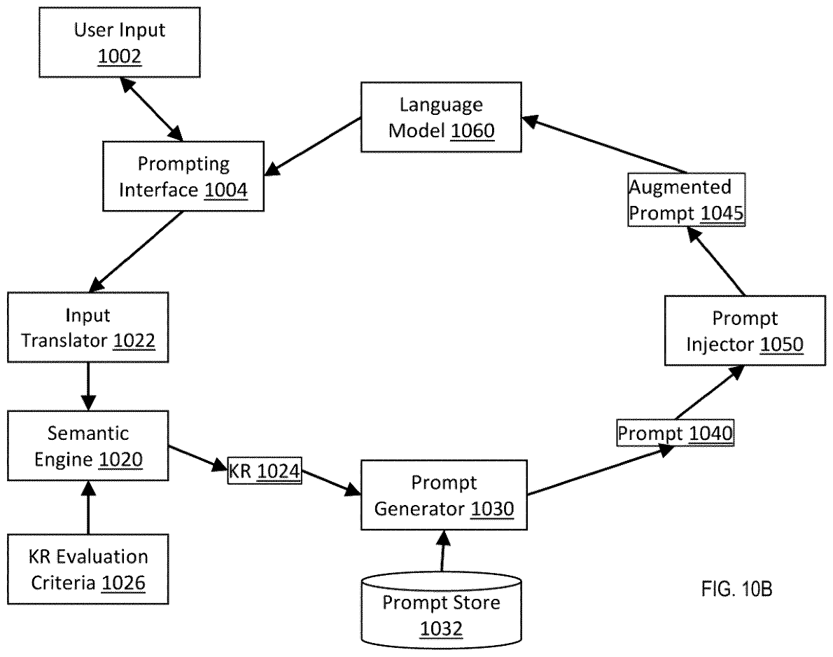

As shown in FIGS. 10A and 10B, a user first provides user input 1002 to a prompting interface 1004. User input 1002 and prompting interface 1004 may be the same as the system shown for prompt engineering in FIG. 3. Optionally, the prompting interface receives additional context (e.g., from an existing user profile, a user model, a history of previous interactions), as part of the user input or as provided by other components in a larger system.

The user can be, for example, a software developer, data scientist or prompt engineer. A user proxy can also be implemented as an automated step that is part of a larger system.

In some variations of this implementation, the prompting interface may facilitate the assembly of a prompt chain, such that the KR (below) could be injected into one or more prompts within the chain. A prompt chain uses the output from one prompt as the input to create a subsequent prompt, creating a chain of related prompts. In other variations, the KR could be injected into one or more independent prompts (a prompt sequence or set).

In FIG. 10A, a prompt augmentation mediator 1010 coordinates the components of the system by following a mediator pattern in software system design.

The mediator pattern defines an object that encapsulates how a set of objects interact. The mediator pattern is considered to be a behavioral pattern due to the way it can alter the program's running behavior. However, any design pattern that allows the execution of a sequence of operations is suitable, such as the pipeline design pattern, which is common in data engineering.

FIG. 10B represents an embodiment where there is no mediator, however, coordination between the components of the system may exist in other forms. FIG. 10A and the discussion below follows the mediator design pattern.

The prompt augmentation mediator 1010 is an example of a component that coordinates the actions of other components within a system. In other embodiments, this role could be achieved by any component which can coordinate the other components such as an “orchestrator” which is similar to a mediator but may not follow a mediator pattern, or an agent. In yet other embodiments, the components could interact directly without an intermediary such as a mediator.

The prompt augmentation mediator 1010 receives the user input 1002 through the prompting interface 1004. The mediator 1010 then provides the user input 1004 to a semantic engine 1020. In some variations, a topic translator 1022 may translate the user input 1002 from an object of interest, from which the semantic engine generates a KR 1024. The KR 1024 can be a taxonomy of concepts in the form of a graph, where nodes represent concepts and edges represent the relationships between concepts. The relationships are either hierarchical (broader or narrower) or non-hierarchical (related). Each node has properties called labels that represent the preferred and alternative (synonymous) ways of describing the concept in natural language.

A set of KR evaluation criteria 1026 establishes which concepts to include in the KR 1024. For the present embodiment, the KR 1024 includes narrower concepts than the initial concepts within the user input 1002 or synonyms for the initial concepts within the user input 1002. The KR should limit broader concepts or related (non-hierarchical) concepts to the initial concepts within the user input 1002. All concepts in the KR should be semantically coherent with each other, including the concepts that explicitly represent the user input. The KR may be graph-based (e.g., on an ontology or knowledge graph) and/or based on the distribution of labels in a text corpus, as determined by querying an index of content or by prompting an LM.

The mediator 1010 next provides a prompt generator 1030 with the user input and, optionally, the generated KR 1024. With this information, the prompt generator 1030 chooses an appropriate prompt 1040. Prompts may be stored in a prompt store 1032 for reuse and easier management. Selection of the prompt 1040 can be user-driven (with the choice explicitly included alongside the user input) or automated. If automated, the choice of prompt can be determined from a configuration file. In another variation, the automated choice of prompt template can be based on a set of heuristics. In another variation, the choice may be based on a prediction from a machine learning (ML) classifier that has been trained to identify the most suitable prompt for the current user input. In the case of heuristics or ML, the KR may be a useful source of information or features that influence the prompt selection.

As described above, a prompt contains instructions for the LM. A prompt can be a prompt template, where the injection site is explicitly indicated by a string of placeholder text (e.g., “[injection site]”). Alternatively, a prompt may not indicate an explicit injection site. In either case, the selected prompt is returned to the mediator 1010 for further processing.

The mediator 1010 next provides a prompt injector with the selected prompt 1040 and the KR 1024. In the case where the prompt has no explicitly marked injection site, some algorithm (e.g., a set of heuristics or a ML model) can be used to identify the best location in the prompt for injection. For example, a simple heuristic can insert an injection placeholder near the end of the prompt, before the commonly used piece of text “Answer:” A prompt template may be expressed as an API, schema, etc.

Once the prompt has an injection site (either because the prompt always had an injection site or because one was inserted), the prompt injector 1050 injects the KR 1024 into the prompt template, replacing the placeholder. In one variation, the KR 1024 can be expressed in a conventional way (e.g., in a textual syntax for RDF called Turtle or in a triple syntax pattern for SPARQL), but this assumes the LM has been trained on texts containing popular formats. Where the conventional way is a graph an example preamble may be “When executing these instructions, the output should be consistent with [constrained by] the graph”. Alternatively, the concept relationships in the KR 1024 can be expressed as natural language assertions (e.g., “Canada refers to the Canadian women's national soccer team”, “Football is equivalent to soccer”). A suitable preamble may be prepended to this list of triples or assertions, such as, for a natural language variation: “When executing these instructions, assume the following assertions are true:”.

With the KR 1024 injected into the prompt 1040, the mediator has an augmented prompt 1045. Next, the mediator 1010 provides this augmented prompt 1045 to the LM 1060 as an input and receives a generated response (an answer) as output from the LM. The generated response is in the form of text.

By including semantically coherent, narrower concepts (and optionally synonyms), the augmented prompt 1045 is more specific than the original prompt 1040. As a result, the generated answer is more likely to evaluate as aligned with the user's intent.

For instance, suppose the user input is “Name a football player who scored for Canada at the World Cup.” Generally, the inclusion of synonyms in the KR helps disambiguate concepts that have shared labels with different meanings. In the current example, the concept “football” can be appropriately disambiguated to refer to “soccer” largely because it is coherent with “World Cup”. Meanwhile, a single narrower concept can also disambiguate a concept's meaning (e.g., “Canadian national soccer team” may disambiguate the use of “Canada”). In some variations of this implementation, additional context from a user model can influence the generated KR further, such that “Canada” refers to women's soccer and not men's soccer (following a user preference for women's sports). In other cases, a sufficient set of narrower concepts will disambiguate a concept's meaning (e.g., “goalkeeper” and “striker” for “football player”). Note that inclusion of broader concepts (e.g., “sport”) or related concepts (e.g. “rugby”) risks broadening the space of possible inferences by the LM and therefore should be excluded from the KR.

In this case, the user intention of “women's soccer” as analyzed from a user preference for women's sport would provide a correct response, while without that analysis, the response provided may be based off of the most recent World Cup or the majority preference for men's soccer over women's soccer.

The mediator 1010 can return the augmented answer to the user via the prompting interface.

Note that the system described in this implementation does not change the state of the LM. Instead, the prompt augmentation system has taken a stateless approach to adapting the behavior of the LM by augmenting its prompt input in real time.

Optionally, a response based on the unaugmented prompt could also be generated by the LM and shown to the user or multiple responses based on multiple augmented responses could be generated by the LM and shown to the user (e.g., in a research or development scenario)

### Using a User-Influenced Knowledge Representation (KR) and a Language Model (LM) to Label Input Data for a Machine Learning (ML) Classifier

A second implementation adapts an LM by generating training data for a secondary ML model. This implementation is shown in FIG. 11.

In some circumstances an ML model is more useful than an LM. An LM may be very large and would not fit on a device with insufficient memory. An LM may be hosted in a data center accessed through the internet which can be expensive both to host and to operate. The results of an LM are not deterministic (the same input can result in a different output). This makes an LM potentially difficult to troubleshoot (lacking predictability and reproducibility) and unreliable (eroding user trust and making it prone to catastrophic errors in some applications). LMs have privacy concerns, since they are generally trained on vast amounts of data, including public data containing personally identifiable information (PII).

However, ML models suffer performance problems when there is insufficient training data relevant to the specific user domain to support the task. For example, a data scientist may lack the data necessary to study an esoteric research question. To achieve the desired level of performance, methods of supervised learning are conventionally deployed, wherein users manually label training data consistent with the task. These supervised approaches impose unacceptable production costs and possible introduction of errors. While training data may be efficiently derived from an LM, or through any unsupervised data generation process, it may not be sufficiently derived for the intended purpose. That is, the subject matter of the generated data may drift from the desired intentions of the user, a problem exacerbated by the generative nature of an LM.

To address these problems, the embodiment of FIG. 11 combines automated (unsupervised) data generation, using an LM, with automated data labeling by a KR-based system, replacing methods of manual data labeling. This dual approach maintains the efficiencies of a fully automated system, while keeping outputs aligned with the intentions of the users. The user configures a process to derive QA pairs from the LM. One such process may use prompt templates, prompt parameters, and/or an existing data source from the user domain to derive inputs to the LM, but many variations to this approach are possible. An input translator transforms the QA pairs output from the LM into inputs for a semantic engine. The semantic engine is configured, as with the previous implementation of FIG. 10, for maintaining the criteria of user-influenced context, semantic coherence with the context, and specificity expressed through predominantly narrower concepts. Each QA pair in the initial training set of the LM is annotated with each QA-specific KR, and the automatically labeled training data is used to train a secondary ML model. In this way, the LM is adapted to produce training data that is more aligned to the intentions of the user.

The embodiments of FIGS. 11A and 11B include a prompting interface 1104 to receive user input 1102, a mediator 1110, an LM 1120, an input translator 1130, a semantic engine 1132, a KR 1140, question-answer pairs 1150, a semantic annotator 1160, an ML pipeline 1170, and an ML classifier 1172.

As with the embodiment of FIG. 10A, the embodiment of FIG. 11A starts with a user input 1102 being received through a prompting interface 1104 and sent to a mediator 1110.

As with FIGS. 10A and 10B, the user input and the prompting interface may be the same as the system shown for prompt engineering in FIG. 3. Again, optionally, the prompting interface may receive additional context (e.g., from an existing user profile, a user model, a history of previous interactions), as part of the user input or as provided by other components in a larger system.

As in FIG. 10A, in FIG. 11A, the mediator 1110 is an example of a component that coordinates the actions of other components within a system. In other embodiments, this role could be achieved by any component which can coordinate the other components such as an “orchestrator” which is similar to a mediator but may not follow a mediator pattern, or an agent. In yet other embodiments, the components could interact directly without an intermediary such as a mediator.

FIG. 11B represents an embodiment where there is no mediator. However, coordination between the components of the system may exist in other forms. FIG. 11A and the discussion below follows the mediator design pattern, as in FIG. 10A.

The mediator 1110 sends the user input 1104 to the LM 1120 which outputs, for the purposes of this embodiment, an LM answer 1122 to the question or request derived from the user input 1104.

The LM answer is sent to the mediator 1110 and then to the input translator 1130. The input translator 1130 extracts QA pairs from the LM Answer 1122 and inputs the QA pairs into the semantic engine 1132. The semantic engine 1132, using KR evaluation criteria 1134, generates a KR for each QA pair and outputs the KR(s) 1140 to the mediator. The KR evaluation criteria 1134 includes criteria for maintaining coherence and specificity of the KRs with the user-influenced context derived from the user input and other data regarding the user.

The mediator sends the KR(s) 1140 along with the associated QA pair(s) 1150 to the semantic annotator 1160. The semantic annotator 1160 automatically labels the QA pairs to generate labeled QA pairs 1155 which are sent back to the mediator 1110.

The mediator 1110 outputs the labeled QA pairs to the prompting interface 1104 for review by the user or by a user proxy. The labeled QA pairs 1155 are then used as a user input into an ML pipeline 1170 as training data for an ML classifier 1172.

One variation of this implementation annotates (labels) a question-answer pair, where an LM is given a question as a prompt and returns an answer. This variation reinforces user intention across the question and answer.

In some variations of the implementation, input to the LM may be a question, but in other variations the input could be an instruction. Similarly, the output of an LM may be an answer, but could also be any generated response by the LM, such as the result of following an instruction.

Another variation involves answers from the LM being annotated by the KR-answer intersection. In this case, the question is discarded and the ML classifier is only trained on labeled LM output (e.g., answers to questions or results from instructions).

Another variation involves the answers being given as input to the LM (instead of questions) and the generated questions are annotated by the KR-question intersection. In this case, the answer is discarded and the ML classifier is trained on labeled questions. Alternatively, the overall answer-question (or result-instruction) pair can be labeled. In this case, the input and output to the LM are simply reversed but the resulting pair still fully participates in the annotation (labeling) process.

We describe the input data for developing an ML classifier in terms of training, but the input data could also be used for other purposes, such as validation, evaluation, and explanation (as is common when developing a ML model). Similarly, when describing an ML training pipeline, this description may be extended to include, for instance, an evaluation pipeline.

### Using a User-Influenced Knowledge Representation (KR) to Develop a Semantic Evaluator for a Language Model (LM)

An LM is enhanced by using a KR to generate a semantic evaluator for the LM. The enhancement uses a configuration similar to the previous implementation, comprising an LM, a user input and user intentions, training data of question-answer pairs, a semantic engine, and an input translator. As discussed above, LMs are notorious for their tendency to hallucinate output that lacks evidence in existing knowledge. This implementation tackles this problem by leveraging the independence that exists between two separate generative systems: an LM and a semantic engine. If the two independent systems generate congruent results using different processes, this congruence increases confidence in the validity of the results. Here, rather than annotating the output of the LM with output from the semantic engine, the system is configured to contrast the two results. The semantic engine is configured using the same criteria as above, applying an analysis of user intentions, and generating semantic representations that are both more descriptive of and more specific than the user context. As applied to the use case of questions and answers, discussed above, an input translator is used to derive corresponding inputs to the semantic engine and the LM. For each input, the semantic engine generates a unique KR representing the user context, and the LM generates an answer representing the user context (that is, the question). In other embodiments where the input-output is not a question-answer, the input may be a prompt or an instruction which results in an appropriate output or completion of the process.

Each KR and its associated answer are evaluated for their congruence using semantic similarity (or relatedness) as a measure. Here congruence is a measure of alignment between the KR and the associated answer which ultimately measures alignment with the initial user intentions. Congruence here may be measured on a spectrum.

In some embodiments, a binary classifier may be used to categorize each result as congruent or incongruent based on measures of semantic similarity. The two categories of congruent or incongruent may still be measured on a spectrum wherein values above a certain threshold result in a classification of congruent and values below the threshold result in a classification of incongruent. In this way, each result can be classified as a “hallucination” (incongruent) or “real” (congruent) with respect to the user's intentions.

The techniques for evaluating semantic similarity may include word embeddings, latent semantic analysis, formal concept analysis, distributional semantics, knowledge-based approaches (incorporating lexicons, vocabularies, and other KRs), and search-based evaluations as discussed in the background. Note that search-based evaluations of factuality (or fact-checking), or “use of affordances,” are among the most common existing approaches, with users manually evaluating LM outputs using search engines. However, as noted in the background, search-based solutions are often based on the same underlying data as large LMs, raising concerns about the interdependence of each source. This implementation recovers independence for the overall system by introducing an additional and fully decoupled generative source.

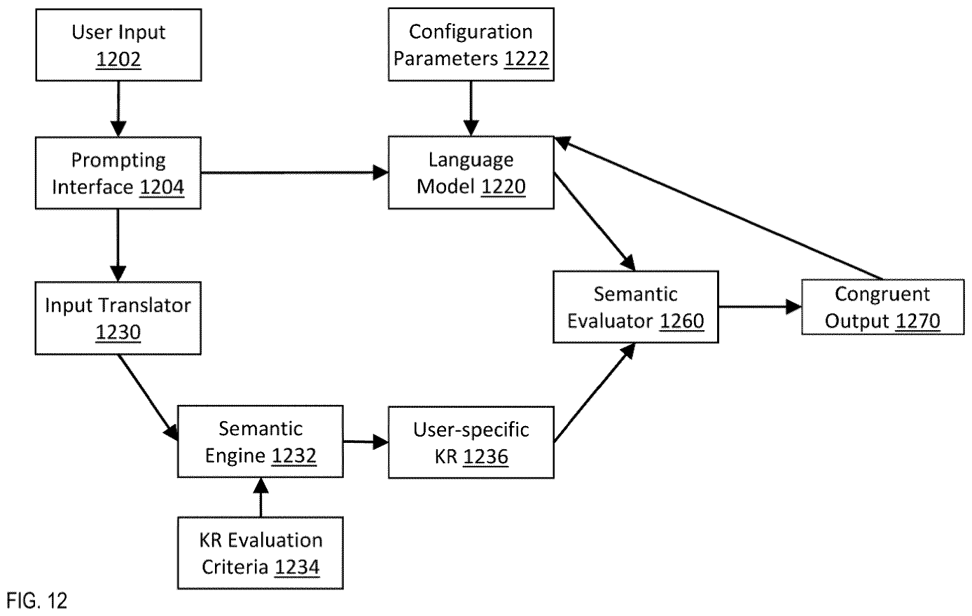

FIG. 12 is a box diagram of the implementation discussed above. FIG. 12 includes user input 1202, a prompting interface 1204, an input translator 1220, an LM or LMs 1230, LM configuration parameters 1232, a semantic engine 1240, KR evaluation criteria 1242, a user-specific KR 1250, a semantic evaluator 1260, and a congruent output 1270.

As with the embodiments of FIGS. 10 and 11, the embodiment of FIG. 12 starts with a user input 1202 being received through a prompting interface 1204. As with FIG. 10, the user input and the prompting interface may be the same as the system shown for prompt engineering in FIG. 3. Again, optionally, the prompting interface may receive additional context (e.g., from an existing user profile, a user model, a history of previous interactions), as part of the user input or as provided by other components in a larger system. In some variations of the implementation, a different interface than a prompting interface may be used.

Although not shown, the prompting interface may interact with the input translator 1220 through a mediator or orchestrator.

The user input 1202 includes both a user request and data regarding the user intentions.

The prompting interface 1204 provides user-influenced data to the input translator 1220.

The input translator 1220 translates the output from the prompting interface into a form that can be input into the LM(s) 1230.

The LM(s) 1230 generates an output based on the user input and sends the output to the semantic evaluator 1260. The output may be a question-answer pair. The LM is trained by training data which is independent from the training data used by the semantic engine 1240. In some embodiments multiple LMs may be used which are all trained on different training data and/or configured from different configuration parameters, and which each generate an output.

The input translator 1220 translates the output from the prompting interface into a form that can be input into the semantic engine 1240, such as a context form.

The semantic engine 1240 uses KR evaluation criteria 1242 to generate user-influenced KR 1250. The user-influenced KR 1250 is sent to the semantic evaluator 1260. The semantic engine may be built from domains of knowledge which are independent from the domains of knowledge used to train the LM. The semantic engine may employ an AKRM.

The semantic evaluator 1260 compares the output from the LM 1230 to the user-specific KR 1250 for congruence and, where possible, outputs a congruent output 1270, which is the “most” congruent output of the LM(s) 1230. In embodiments where there are multiple LMs the outputs from each LM are compared to the KR 1250.

A binary classifier may also be used to classify each output as either coherent or incoherent. While congruence and coherence may be measured using the same methods and values, coherency may be measured in a binary system where there may be a threshold value above which an output is labeled as coherent and below which an output is labeled as incoherent, while congruence is measured on a spectrum such that the “most” congruent output has the highest score or ranking. These labels may be reversed or other terms may be used. These classifications and labels may be relevant when using the outputs as training data.

The congruent output 1270 can then be used to further train a specific LM 1230 to be adapted to the user, while any non-congruent outputs can also be used to train an LM to create a user-adapted LM.

Using an Atomic Knowledge Representation Model (AKRM) to Evaluate Candidate Output from a Language Model (LM)

An LM is enhanced using a user-specific KR to evaluate and select from possible outputs. This implementation is an extension of the previous implementation and further includes an AKRM.

Existing evaluative methods are typically applied prior to the generation of the LM output. For example, criteria may be selected to align with an existing domain of knowledge or the intended task for the LM. As discussed above, the LM is used to generate new knowledge, not to retrieve existing knowledge, which challenges any approach that establishes selection criteria in advance of the output. Accordingly, this implementation generates a user-specific KR, representing the meaning of user prompts or user intent, in parallel with the generation of the LM output, and derives evaluative criteria from the KR. It begins by configuring one or more LMs to generate a variety of outputs for a given prompt. There may be a variety of methods available to cause an LM to generate multiple outputs, such as adjusting the LM's sampling parameters to increase non-determinism in its output, in combination with adjustments to the number of completions the LM attempts to make for the given prompt. Sampling parameters include temperature, a seed to initialize randomness, top P, and other conventional settings for LMs.

Alternatively or additionally, a set of different LMs could be prompted. Differences across these LMs could be due to having been trained and/or fine-tuned on different datasets, although variation in configuration parameters could also apply here.

In parallel, this implementation incorporates a process of semantic data generation, using the same AKRM criteria as in previous implementations, specifically the embodiment discussed for FIG. 12, to generate a KR for the corresponding LM prompt. The LM prompt may be extended as a prompt chain to create more comprehensive KRs, depending on the tasks and domains. Here, the components used to implement the AKRM are derived from the LM, and other tools may provide the desired functionality, including that a different LM could be used such that the AKRM and the LM being adapted are independent. In this implementation, the LM is used to disambiguate and link tokens (as entities) from the user prompts to internal representations, as relatively simple (or atomic) concepts and concept relationships. For each prompt, a semantic engine generates a KR, which is conventionally implemented as a graphical data structure having concept nodes (representing entities) and relationship edges (representing connections between entities). As a result, each prompt is represented as a graphical data structure in place of unstructured or semi-structured text. Alternative data structures may be used to represent the KR.

The LM is then used again to produce natural language labels for each node in the KR. The set of labels is reconstituted into a natural language summary of the KR. A semantic evaluator is used to compare the generated KR with the set of candidate outputs from the LM. The semantic evaluator may be similar to and generated in the same way as the semantic evaluators discussed above in other implementations, for example semantic evaluator 1260 of FIG. 12. As in the previous implementations, this evaluation may be based on measures of the semantic similarity between the natural language summary of the KR and the candidates produced by the LM. The embodiments include other alternative ways of evaluation, including search techniques.

As with the embodiment shown and discussed in FIG. 12, the most congruent output, as determined hereby evaluating the semantic similarity between the KR and the outputs of the (at least one) LM would be chosen as the output which most aligns with the user's intent. The outputs may be assessed by a binary classifier as coherent or incoherent based on semantic similarity, as described above for FIG. 12. Regardless of the congruence or coherence of each output, the outputs can be used as training data for an LM to be adapted based on information from and about the user. Congruent or coherent output can be used for conventional training of an LM, while incongruent or incoherent output can be used for contrastive training of an LM.

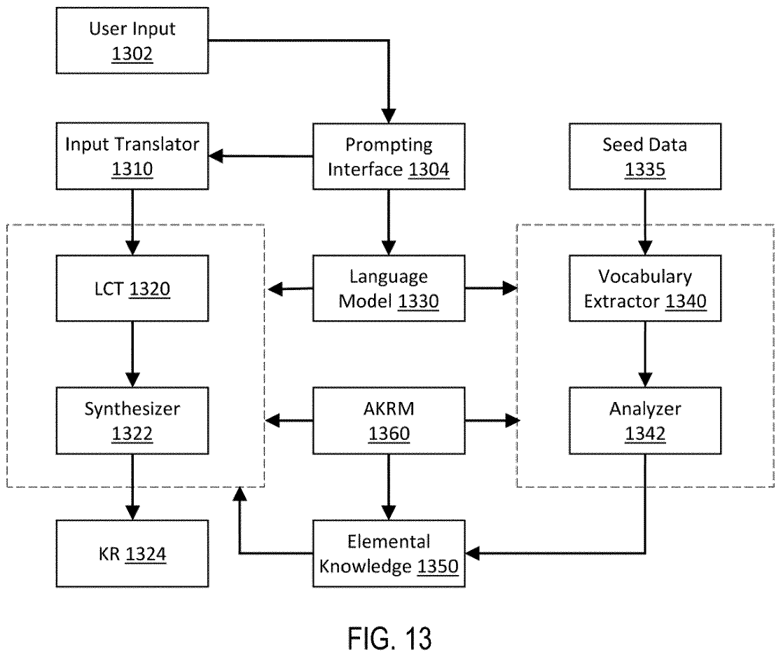

FIG. 13 is a box diagram of the interactions of an example system for the implementation discussed above, leading up to the generation of a KR 1324. At this point, FIG. 12 depicts the remaining steps, from KR 1236, through the semantic evaluator 1260, LM 1220 and resulting in congruent output 1270.

FIG. 13 includes user input 1302, a prompting interface 1304, an input translator 1310, a label-to-concept translator (LCT) 1320, a synthesizer (or generator) 1322, a KR 1324, at least one LM 1330, seed data 1335, a vocabulary extractor 1340, an analyzer 1342, atomic knowledge 1350, and an AKRM 1360.

The LCT 1320 and synthesizer 1322 comprise a semantic (KR synthesis) engine (dashed line box). The function of this semantic engine can be performed online (in real time) and includes receiving an input and outputting a KR. In some variations of this implementation, an offline generation process could be used as batch processing.

The LCT 1320 is an example of a component of an adaptation method which itself generates user-influenced data, for example in the form of KR 1324.

The vocabulary extractor 1340 and analyzer 1342 comprise an analysis engine (dashed line box). The function of the analysis engine normally occurs offline and includes developing and building a model of elemental knowledge 1350 from input seed data 1335, including KRs. In some variations of this implementation, the analysis engine could operate online as a service, as a way for a user to build a new model or update an existing model.

In the embodiment of FIG. 13 as with the other embodiments above in FIGS. 10A-13, a user input 1302 is received through a prompting interface 1304. The user input and the prompting interface may be the same as the system shown for prompt engineering in FIG. 3. Again, optionally, the prompting interface may receive additional context (e.g., from an existing user profile, a user model, a history of previous interactions), as part of the user input or as provided by other components in a larger system. In some variations of the implementation, a different prompting interface may be used, such as a word processor.

Although not shown, the prompting interface may interact with the input translator 1310 through a mediator or orchestrator.

Tasks which can be accomplished by the system of FIG. 13 are discussed below.

As an explanatory model, through the use of knowledge processing rules, the AKRM 1360 describes how to build a dataset of elemental (atomic) knowledge 1350. An implementation of the AKRM typically involves tasks akin to natural language processing, but in this embodiment one or more of these tasks could be served by one or more LMs 1330.

As described in U.S. Pat. No. 11,474,979, incorporated herein by reference, the analysis process is normally offline and begins with a vocabulary extractor 1340, which analyzes a set of knowledge sources that are unstructured, structured or semi-structured. In this implementation, the LM(s) can be prompted by the vocabulary extractor to extract or summarize the complex concepts from text for a given knowledge source, such as an ontology or other complex vocabulary. This use of the LM(s) essentially implements information extraction (both entity extraction and relationship extraction) in place of conventional NLP approaches to that task.

In some variations of this implementation, the vocabulary extractor can prompt the LM(s) to provide supplemental meaning for the extracted concepts by generating text descriptions or additional complex concepts and relationships to include in the vocabulary.

The output of the vocabulary extractor 1340 is a set of input KRs for the analyzer 1322. The analyzer next decomposes the input KRs into smaller, atomic or elemental concepts and relationships 1350. In this implementation, instead of relying on conventional text processing techniques, the analyzer can prompt the LM(s) 1330 to identify smaller, independent concepts (atomic concepts) within the more complex concepts from the vocabulary extractor 1340. In other variations, the LM(s) 1330 may also be prompted to evaluate possible relationships between the atomic concepts as a form of relationship discovery. As is the case with prior use of AKRM, the resulting collection of atomic concepts and relationships from the analysis engine can be described as a large graph of elemental knowledge 1350.

As an explanatory model, again through the use of knowledge processing rules, the AKRM 1360 also describes how to use the elemental knowledge 1350 to synthesize or generate KRs 1324. This is normally an online (real-time) process, which begins with an object of interest that is provided to the synthesis engine by a user, although it could also be provided by a user proxy within a larger, automated system.

Within the synthesis engine, to disambiguate word senses and link entities, the role of an LCT 1320 is to convert the object of interest from the input translator 1310 into a set of corresponding concepts within the atomic knowledge graph. In this implementation, the LCT 1320 can explicitly prompt the LM(s) 1330 to propose which atomic concepts correspond to the user input, given a grounded list of candidate concepts.

From these atomic concepts, the synthesizer 1322 traverses the elemental knowledge graph 1350, seeking candidates for generating new concepts and relationships that could be coherent with the user input from 1310. Knowledge processing rules in the AKRM 1360 dictate how the synthesizer can combine the visited concepts and relationships in the graph, while the LM(s) 1330 could be prompted to validate these choices.

The synthesizer 1322 also includes a scoring mechanism that assesses the coherence of synthesized concepts with the input concepts corresponding to the user's object of interest. The most coherent concepts are included in the generated KR 1324. In this implementation, the LM(s) 1330 can be prompted to serve as a ranking function, the result of which can be interpreted as one of many contributing scoring functions when assessing the semantic coherence of synthesized concepts in the KR.

Synthesized concepts are inherently complex and require new labels to describe their semantics in natural language for the benefit of human users. Although rules in the AKRM 1360 can be used to combine the labels of a complex concept's parts, a rule-based approach often results in suboptimal and even ungrammatical output. In this implementation, the synthesizer 1322 can instead prompt the LM(s) to generate natural-sounding surface labels for synthesized concepts in the KR 1324.

The synthesizer 1322 can also prompt the LM(s) 1330 for a natural language summary of the entire KR 1324. As described earlier, this KR summary may be compared with the candidate outputs of the LM being evaluated, as a basis for determining the coherence or congruence of the LM outputs with the user input.

### Using a User-Influenced Knowledge Representation (KR) and a Language Model (LM) to Manage Conditioning Variables

An LM is enhanced using a user-specific KR to select and manage conditioning variables derived from the user input or user information such as a user instruction set or user profile. This implementation is an extension of the previous implementation and further includes a mechanism to inject the user-specific KR, representing the selected and managed conditioning variables, into the LM prompt.

The management of conditioning variables is a critical task across many fields, including ML and statistics. Generally, conditioning variables are used to provide context or control of confounding factors (that is, the factors or variables that may introduce bias). In ML and statistics, conditioning variables are also known as covariate or control variables. In LMs, conditioning variables are used to provide context for predictions. In simple applications, conditioning variables may be used directly as context, as in the prompts provided to LMs. In more complex applications, conditioning variables may be derived from sources external to the models, such as knowledge bases, user profiles or activity logs.

When managing conditioning variables, the main goal is to isolate the effect of variables of interest by reducing or eliminating the impact of other variables. There are many techniques used to manage conditioning variables, such as stratification, multivariate analysis, or randomization, and the application of these techniques may vary across their fields of use. Generally, causation plays an important role in many techniques, implicitly or explicitly. The knowledge of how an underlying system works has a critical impact on the identification and management of conditioning variables. Causal relationships across variables suggest how variables may contribute to outcomes, which in turn may suggest appropriate techniques for identifying and managing conditioning variables.

With black box machine learning, however, particularly in the area of LMs, the causal mechanisms are not always clear and are often missing entirely. Consequently, the design and use of these black box systems is subject to trial-and-error experimentation. Different sets of conditioning variables are explored in post hoc combinations. Tools are provided to accelerate this process, such as interfaces that provide for the rapid selection of conditioning variables, but the process is cumbersome and prone to unintended outcomes.

There are at least two opposing forces underlying the dynamics of conditioning variables and their management.

On the one hand, the set of possible conditioning variables becomes more constrained as the mechanisms of the underlying system become better understood. For every discrete behavior or task, the conditioning variables may converge on a discrete set, representing an optimized solution. There will emerge specific and discrete sets of conditioning variables that optimize the capabilities of the model in targeted, controlled ways. For example, personas may be defined for the desired behavior, such as an historical figure, or roles may be defined for the intended task or function, such as an accountant or lawyer.

On the other hand, the space of possible conditioning variables and their values grows with the number of model parameters (internal weights and biases). The model is able to express a higher level of complexity in the generated output, integrating more nuanced and multifaceted instructions or contexts. For example, a relatively small model may be able to discern between aspects of tone (formal, informal, etc.) but not aspects of style (descriptive, expository, narrative, etc.). As the size of the model grows, new facets will emerge as viable conditioning variables. Continuing the example, the larger model will incorporate aspects of voice, mood, or even intentionality. The largest models begin to simulate personalities as individual as their users.

There are a number of high level organizing bases for conditioning variables. Sets of conditioning variables may be prepared based on the desired behavior of the model or the intended tasks or functions for the model. Optimized sets of conditioning variables may be organized using taxonomies or other organizational schemes, such as ontologies or knowledge graphs, to facilitate their management. As the desired behavior is discovered or the tasks solved, the determining conditioning variables are persisted, while unintended or counterproductive variables are discarded. Taxonomies are often used to make these sets accessible and modifiable in the future. Facets such as the desired topic or subject area, the desired tone or style, provide top-level classes. Various strategies are used to identify these optimized conditioning variables, including the analyses of the prompts used by experts or of the documents representing a domain of expertise.

As in the previous embodiments, the problem is that existing management strategies are regressive or backwards-looking; these solutions encode existing knowledge acquired through trial-and-error. The promise of these generative systems is not the retrieval of existing knowledge but the creation of new knowledge. There is an unbounded space of potential behaviors and tasks to be discovered in collaboration with users, and an unbounded range of potential discrete sets of conditioning variables that may emerge to be managed.

Accordingly, as with the previous implementation, this implementation generates a user-specific KR, representing the meaning of user inputs (or user intent). This acts as a preliminary stage to the main LM generation process. This approach is useful when conditioning variables cannot be managed during model training, in the traditional sense. This alternative method uses techniques of semantic data generation—for example, using the AKRM criteria as in previous embodiments—to generate the user-specific KR.

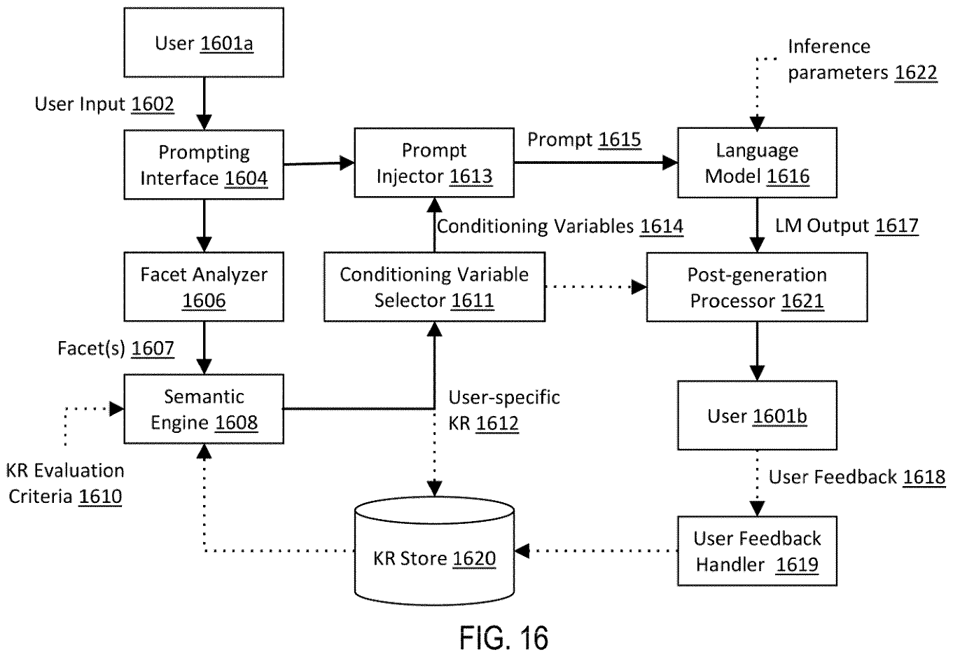

FIG. 16 is a box diagram of an overview of how a user-influenced KR is used to derive and select dynamic conditioning variables to enhance an LM within the systems and methods described herein. Those skilled in the art will understand that there are multiple design patterns to support a flow of functional components, such as those illustrated here, including the mediator and pipeline patterns discussed previously.

As shown in FIG. 16 and explained earlier in FIGS. 10A and 10B, a user first provides user input 1602 to a prompting interface 1604. User input 1602 and prompting interface 1604 may be the same as the system shown for prompt engineering in FIG. 3. As discussed previously, the prompting interface may facilitate a chain of prompts to support a variation discussed below, wherein conditioning variables are injected into more than one prompt.

In order to manage the conditioning variables, the terms extracted from the user input are analyzed to determine facets or high-level categories using a facet analyzer 1606. There are many technologies and approaches available for this analysis, including unsupervised clustering or the use of LMs. For example, an instruction may be passed to the LM: “Identify a set of keywords or key phrases to associate with the prompt (or user input) and generate a high-level category (or facet) to represent the meaning of the set of keywords.”

One or more methods of KR synthesis are applied to these extracted keywords to extend the main facet to new concepts and concept relationships. The user-specific KR 1612 is a data structure as described previously, which again may take the form of a hierarchical graph composed of concepts (nodes) and semantic relations (edges). A semantic engine 1608, configured with evaluation criteria 1610 as with the previous embodiments—to enforce the criteria of user-influenced context (drawn from the prompt or user input), semantic coherence with the context, and specificity expressed through predominantly narrower concepts—may be used to perform this KR synthesis.

Prior to the main LM inference generation 1616, conditioning variables 1614 are selected using the user-influenced KR. In a simple case, the conditioning variables are selected by traversing the user-influenced KR using the facets and terms (facet values) associated with the user input. For example, if the user input is associated with the facet: subjects and the terms {airplanes, warfare, tactics}, then the user-influenced KR may produce a set of additional conditioning variables, {dogfighting, interceptors, strategic bombing, electronic warfare}, which are not present in the user input.

The selected conditioning variables are injected into the user prompt, via the prompt interface, using a prompt injection method, discussed previously. Note that a multi-step method of prompt injection may also be applied, as in a dialog with a conversational LM. Conventionally, this approach begins with the identification of a role, such as “You are an expert financial analyst.” Here, a large set of conditioning variables is composed as the user-influenced KR to be injected into the conversation over multiple interactions. This approach is useful for simulating a gradual unveiling of the desired or intended “personality” of the LM, or alternatively, to simulate a gradual understanding of the subject matter.

Based on user feedback 1618, the user-influenced KR may be persisted in a KR store 1620, such as a database, to influence future interactions with a user, or to reflect the “personality” of an organizational or collective application. This storage is also useful when the user input or prompts are sparse, as with new users of an LM; those familiar with the art will recognize this as a cold start problem. The stored set of user-influenced KRs may also be shared to reflect desirable “personalities” or styles, in addition to or in place of the conventional practice of prompt guides. Those skilled in the art will recognize the many approaches of data analysis to derive novel inputs or new sets of conditioning variables from this new data source, as well as using the stored KRs as input to semantic engine 1608.

Those skilled in the art will also recognize other methods to use conditioning variables to influence the LM generated output. For example, instead of indirectly influencing the output pre-generation, the output may be directly processed post-generation, through text editing or formatting operations (such as removing, adding, or replacing key terms and phrases). Alternatively, conditioning variables may be evaluated with respect to various inference parameters, such as adjusting the temperature setting to align more closely with the intended meaning of the output, as suggested by the conditioning variables.

Using an Atomic Knowledge Representation Model (AKRM) as a Source of Logical Constraints when Training a Probe for Assessing the Semantic Consistency of a Language Model (LM)

An LM is enhanced by incorporating logical constraints derived from evaluations of semantic coherence across the LM. This implementation comprises an LM, a semantic engine, a semantic evaluator, an input translator, and a loss function optimizer. As discussed in the background, LMs may not possess an understanding of the meaning of all the predicted word sequences. This implementation generates an ML model as a probe to evaluate the performance of the LM in terms of its semantic consistency, based on an explanation of the expected structure of coherent semantic information. An explanation of semantic coherence is expressed as logical constraints for use in an enhanced loss function optimizer. The semantic coherence of the LM is evaluated using a semantic evaluator configured as an AKRM. AKRM imposes consistency constraints based on the compositionality of concepts and concept relationships. Under AKRM, every composed concept entails a relationship across the simpler concepts that compose it. Based on this insight, the loss function optimizer may be enhanced to enforce this semantic consistency. As input to the optimizer, a KR is analyzed based on the constraints of AKRM to derive a set of foundational (or relatively simple) concepts and concept relationships. KRs with a high degree of truth-preserving authority and semantic simplicity may be used, such as lexicons, controlled vocabularies, or upper ontologies. For each set of concept relationships, internal representations are extracted from the LM. A mapping is prepared between the set of semantically derived QA pairs and the corresponding internal representations of the LM. The unsupervised loss for the ML is optimized to maximize the consistency of the semantically derived logical constraints. In this implementation, the starting point is with an AKRM, which establishes constraints on the structure of semantic data. That is, for the output of an LM to be deemed semantically coherent, the structure of that data would be consistent with the data generated under AKRM. This implementation reformulates these semantic constraints as a set of logical negation consistency constraints. The embodiments include alternate ways to apply consistency constraints to adapt an LM.

Here, the AKRM has analyzed a set of trustworthy knowledge sources for specific or various domains. Possible knowledge sources can be unstructured (e.g., email, enterprise documentation, product descriptions, job descriptions), structured (e.g., ontologies, taxonomies and other controlled vocabularies) or semi-structured (i.e., a mix of structured and unstructured data).

The AKRM is used to generate a set of statements (or assertions) consistent with its encoded knowledge about the input sources. For example, the AKRM may have discovered a hierarchical relationship between “doctor” and “professional”, given the hierarchical relationship between “Doctor of Medicine” and “professional degree”. The resulting statement would be “A doctor is a professional” or some well-formed and accurate variation. In some embodiments, the variation could be a structured representation, such as a logical form (e.g., is_a (doctor, professional)). The choice of representation may depend on the data used to train the LM being probed. If the LM hasn't been trained on sufficient amounts of data containing structured representations, then the natural language formulation will be preferred.

Each statement is rephrased as a pair of yes/no questions. This rephrasing process yields a contrast pair for each question. Following the same example, a contrast pair would be “Is a doctor a professional? Yes.” and “Is a doctor a professional? No.” Alternatively, it could be “is_a (doctor, professional)=true” and “is_a (doctor, professional)=false”.

For each contrast pair, internal representations from the pretrained LM to be probed are extracted and normalized. These extracted representations will be used as features for training a secondary ML model. Normalization removes the effect of formulating each statement as a yes/no question.

Using conventional ML techniques, a probe model is trained as a binary classifier that can predict whether the LM returns a given question as true or false. This result reflects the LM's latent or parametric knowledge about the given question. The binary classifier can be linear or nonlinear, although a simple linear model may be sufficient.

The probe model has an unsupervised loss function, which the training process optimizes, thereby learning the probe model's parameters. Specifically, the loss function includes a consistency constraint that, for a given contrast pair, minimizes the difference between the probability of a true statement (e.g., p (“Is a doctor a professional? Yes”) or p(is_a (doctor, professional)=true) and the complement of the probability of the false statement (i.e., 1−p(“Is a doctor a professional? No”) or 1−p(is_a (doctor, professional)). If the LM is perfectly consistent in its latent knowledge for the given contrast pair, then both calculations will be identical and the consistency loss will be zero.

Variations of this implementation may include additional constraints in the probe model's loss function to avoid degenerate solutions. In some variations, this could be a confidence constraint that, for a given contrast pair, calculates the minimum of the probability of the true statement (e.g., p (“Is 2+2=4? Yes” could be 0.9999) and the probability of the corresponding false statement (e.g., p (“Is 2+2=4? No” could be 0.0001). When the LM's latent knowledge is “confident”, the minimum of these two probabilities will be zero or close to zero.

Once the probe has been trained, it may be used to assess the latent knowledge of the LM on a specific set of yes/no questions having expected answers. The assessment of the LM's latent knowledge may then be used to identify its limitations, as well as opportunities for improvement. For instance, areas of knowledge for which the LM gave incorrect answers may indicate specific gaps in the training data for the LM. Identifying these gaps can lead to retraining the LM or fine-tuning the LM or its tokenizer with more comprehensive data. In some applications of this implementation, identified gaps in the LM's knowledge could be filled through prompt augmentation, such as the injection of a KR into the prompt (as described earlier in this application).

### Using Knowledge Generation Rules to Self-Train a Language Model (LM) by Selecting Semantically Coherent Concepts

Self-training is a form of semi-supervised learning wherein a model, such as an LM, uses its own predictions to generate new training data. These techniques may include methods of data augmentation, such as back translation (reverse translation), text augmentation, Q&A synthesis, programmatic labeling, and co-training. The data is augmented to either diversify the examples within a given set of training data, or to create entirely new data.

Another major category for improving LMs uses reinforcement learning from human feedback (RLHF). Variations of this approach, called reinforcement learning from AI feedback (RLAIF) and LLM-as-a-Judge, use LMs to provide evaluation, feedback and responses. Methods of data augmentation, reinforcement learning, and instruction may be combined in different solutions. The models built from this data may be evaluated for robustness using techniques such as uncertainty estimation, regularization (e.g. dropout), and graph-based confidence assessments. There are other methods of verification that depend on external feedback and human annotators, such as theorem verifications, unit tests, adversarial testing, sensitivity analysis and transfer learning evaluation (on different tasks or domains). These methods are usually specific to a knowledge domain and inherit the same limitations as domain-specific data, namely insufficient generalization.

In the context of the present invention, self-training is applied to address problems of data sparsity, where there is insufficient training or evaluation data, particularly with respect to the users' specific knowledge and interests. In these environments, existing self-training techniques may fail to augment existing training or evaluation data effectively, leading to noisy, inaccurate, or misleading examples. In other cases, where the new knowledge is esoteric or non-derivative, there may be no existing training or evaluation examples upon which to draw. In these environments, self-training techniques may lead to noisy, inaccurate or misleading data.

Among the capabilities needed in the self-training system is a deep understanding of the semantics and common sense that underlies coherent and accurate models. For example, semantic entailment relations may be used to generate more dependable training or evaluation data. This technique uses a prompting strategy to formulate an NLU task as contextual entailment. Generally, given a premise and a hypothesis, the task is to determine whether the hypothesis logically follows from (entails) the premise. The limitation of such methods is the need for high-quality labeled entailment data, which is again frustrated by the environment of sparse data in creative and esoteric knowledge environments.

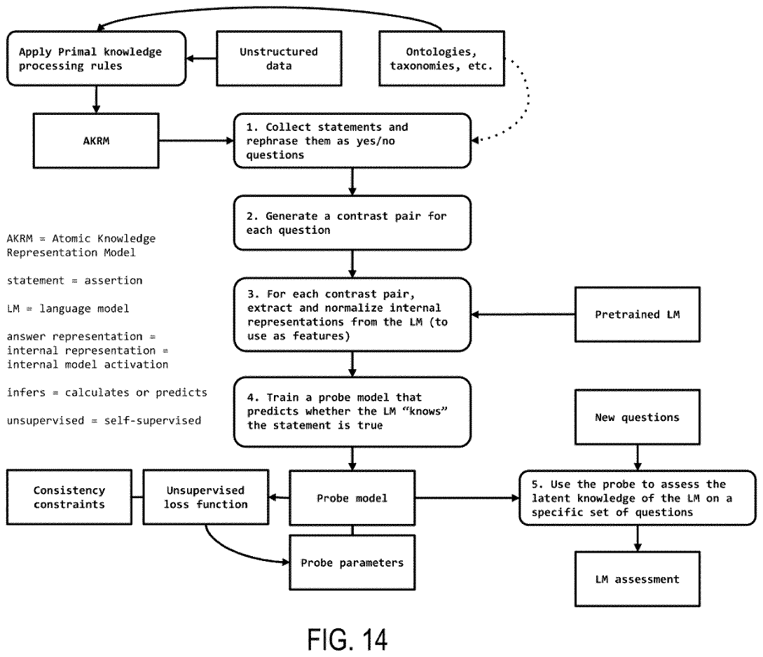

A solution to these challenges disclosed herein draws on an explanation of how coherent semantic data may be generated and evaluated. This explanation, called an AKRM, was discussed above in the context of FIGS. 8 and 14. Here, the AKRM is described more fully and is applied to a method of self-training that produces data for an ML pipeline. Those skilled in the art will recognize how this general explanation of coherent semantics and ML may be applied to other methods of self-training.

The intent of the following self-training is for the LM to recognize and apply an internal structure for coherent semantic data. That is, the structure of coherent semantics is made explicit and then expressed in data, which in turn may be used to recognize the structure of coherent semantics when provided an esoteric context or novel input.

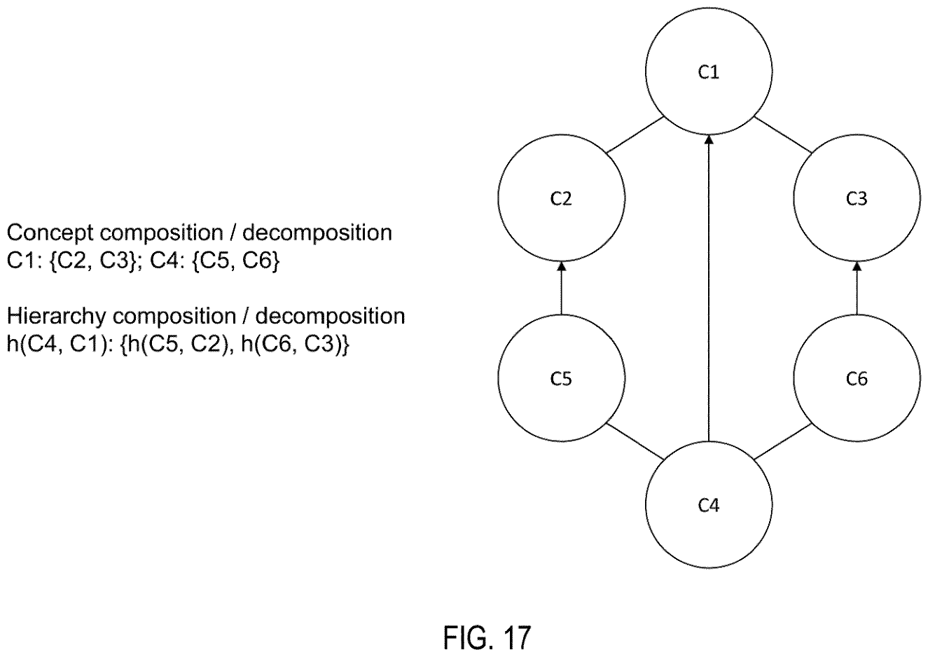

FIG. 17 is a simple illustration of this structure of coherent semantics that is imposed through this method on the LM. These rules are symmetrical, in that rules of analysis are used to decompose complex concepts into simpler concepts, and corresponding rules of synthesis are used to compose complex concepts from simpler concepts. For simplicity, the examples are constrained here to two basic rules: a) concept composition or decomposition; and b) hierarchical relationship composition or decomposition. Taken together, these two rules may be used to deconstruct complex knowledge representations by operating iteratively across seed data and synthesized data, and symmetrically, to construct complex knowledge representations from simple seed data and analyzed data. This compositional approach allows AKRM-based systems to manage large knowledge models, creating increasingly complex concepts from simpler antecedents. In FIG. 17, concept C1 is composed of concepts C2 and C3; or alternatively, the concept C1 may be decomposed into concepts C2 and C3. Similarly with concept C4, composed of concepts C5 and C6. If concepts C1 and C4 are in a hierarchical relationship, hierarchical relationships may be inferred across C2 and C5, and C3 and C6. That is, the complex relationship between C1 and C4 may be decomposed into simpler relationships between C2 and C5, and C3 and C6; and a complex relationship between C1 and C4 may be composed using the relationships between C2 and C5, and C3 and C6.

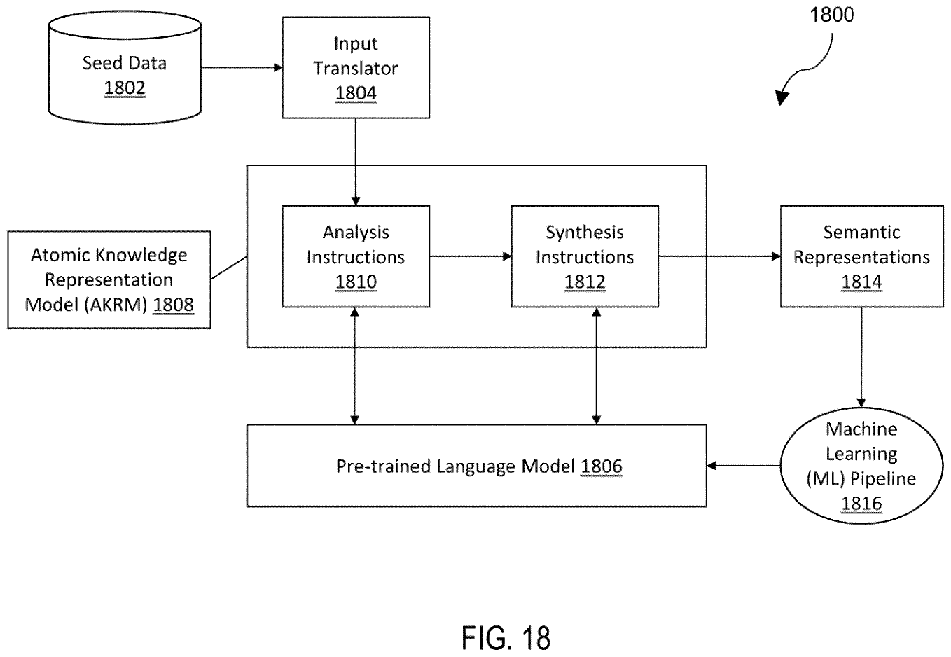

FIG. 18 depicts an overview of a system 1800 for self-training an LM using knowledge generation rules to select semantically coherent concepts.

In the analysis stage, seed data 1802 is analyzed to discover the composition of coherent concepts and concept relationships. The method begins with seed data as a set of trustworthy knowledge sources that covers simple, base or common knowledge. Examples may include lexicons, upper ontologies, or high quality encyclopedic knowledge, where data is typically structured as RDF (Resource Description Framework), OWL (Web Ontology Language), XML (extensible Markup Language), or other types of structured formats designed for semantic clarity and interoperability. These data sources may be extended to domain-specific areas such as medical legal vocabularies. The intent is to seed the system with relatively simple and high quality data (referred to as seed data), with which the data synthesis process can begin.

First, the seed data 1802 is transformed into natural language using an input translator 1804 that optionally interfaces with a pre-trained LM 1806. For example, a lexicon entry of “is_a (orchard, garden)” may be translated into the statement, “an orchard is a garden.” Those skilled in the art will recognize that this translation step can be achieved with a pre-trained LM or with some other NLP technique that generates natural language from a structured or machine-readable representation of text. The natural language statement, with or without the original structured representation, is then included among the instruction sets that follow. If the input translator has an input length limitation, then subsets of the seed data may be processed iteratively. These modifications for interfacing with various input translators (such as LMs) are well understood.

An AKRM 1808 applies generative rules to the analysis and synthesis of complex semantic concepts.

The following pseudocode illustrates a method for generating atomic concepts and relationships through the analysis stage, or for generating complex concepts and relationships through the synthesis stage (depending on an input parameter that indicates which stage to run):
GenerateKnowledge
Input:
CONTEXT: User and/or application context (e.g., requests, active concepts, domain restrictions)
KRᵢₙ: Knowledge representation (e.g., taxonomy)
RULES: Coherent Concepts, Hierarchical Relationships
STAGE: One of {ANALYSIS, SYNTHESIS}
Output (of synthesis):
Complex concepts and relationships in an output Semantic Representation
Side effect (of analysis and optionally synthesis):
Materializing new atomic concepts and relationships in the AKRM

### Procedure:

| | |
|---|---|
| Cₐ = AKRM.C | /* A set concepts definitions defined in the |
| | AKRM */ |
| Rₐ = AKRM.R | /* A set of concept relationships defined in |
| | the AKRM */ |
| C = { } | /* A set of new, complex concepts */ |
| R = { } | /* A set of new, complex relationships */ |

```
If (STAGE is ANALYSIS) {
  For each analysis rule in RULES {
    Apply the analysis rule to (KRᵢₙ, Cₐ, Rₐ) to generate a set of new
    atomic concepts and relationships
    /* Materialize the new data in the AKRM */
    Cₐ = Cₐ U {set of generated atomic concepts}
    Rₐ = Rₐ U {set of generated atomic relationships}
  }
}
If (STAGE is SYNTHESIS) {
  For each synthesis rule in RULES {
    Apply the synthesis rule to (Cₐ, C, Rₐ, R, CONTEXT) to generate a
    new set of complex concepts and relationships
    C = C U {set of generated complex concepts}
    R = R U {set of generated complex relationships}
    /* Possibly materialize a subset of the generated KR in the AKRM */
    If enough support (or if explicitly requested by the user):
      Cₐ = Cₐ U C and Rₐ = Rₐ U R
  }
  KRₒᵤₜ = (C, R)
  Output the complex KRₒᵤₜ to the user or application
}
```

The following examples formalize the rules presented above for analyzing and synthesizing coherent concepts and hierarchical concept relationships.

### Input/Output:

A set of concepts C
A set of acyclical, hierarchical relationships H={h(cᵢ, cⱼ): cᵢ, cⱼ∈C and cᵢ Is-a cⱼ}
Rule 1 (Coherent Concepts Synthesis): Create a new concept c={cᵢ, cⱼ}, c is said to be composed of cᵢ and cⱼ if and only if cᵢ and cⱼ. Two concepts cᵢ, cⱼ are considered coherent if according to some distance metric M, M (cᵢ, cⱼ)<T, where T is a predetermined threshold. Possible example metrics include: frequency of co-occurrence of the two concepts in an input corpus, or a tree distance function applied on the taxonomy hierarchy.
Rule 2 (Hierarchical Relationship Synthesis): Let c₁={c₁₁, c₁₂, . . . , Cin} be a concept composed of n concepts, c₁₁ to c₁ₙ. Similarly, let c₂={c₂₁, c₂₂, . . . c₂ₘ} be a concept composed of m concepts, c₂₁ to c₂ₘ. Create a new hierarchical relationship h(c₁, c₂) if and only if for each c₁ᵢ there exists for some concept c₂ⱼ. a hierarchical relationship h(c₁ᵢ, c₂ᵢ) or an equivalence relationship e (c₁ᵢ, c₂ᵢ).

Again, for simplicity, a simple hierarchical relationship rule is presented, which may (for example) represent a hypernym or hyponym relationship, superordinate or subordinate relationship, etc. Those skilled in the art will appreciate that more complicated rules may be constructed to explain the underlying bases of more complex conceptual semantics.

In the synthesis stage, seed data is combined with analyzed data to compose new concepts and concept relationships.

Continuing the example above, assume the hierarchical relationship “h(-ist, -er)” is also among the analyzed data, where the suffix-ist expresses expertise and is more specific than the suffix-er, which expresses engagement in an activity. Given the context, “fruit”, and the instructions presented in the pseudocode, the LM might synthesize complex concepts, (orchard, -ist) and (fruit, garden, -er), as well as the complex relationship, h ((orchard, -ist), (fruit, garden, -er)). Note that the synthesized data may contain both valid and invalid data (tolerated by the system as acceptable noise), as well as real and imagined data (such as neologisms). In this example, “orchardist” is an existing English word, but it's rare and, along with its relationship to the complex concept (fruit, garden, -er), may not be in the original lexicon. Similarly for the example, h(-ist, -er), which may be identified as coherent data that satisfies the AKRM constraints, but not otherwise available through conventional sources (such as the seed data discussed earlier), or otherwise discoverable through human analysis.

The preceding processes of analysis and synthesis generate data that is assembled into one or more output semantic representations. This construction may be used to validate or invalidate synthesized concepts by applying constructive rules to the overall semantic representation. For example, rules may permit (or forbid) poly-hierarchies, or rules may constrain the minimum or maximum instances within a class. Complementary systems of validation, such as those discussed in other embodiments, may also be applied.

Once validated, the synthesized data is available for use in one of the adaptation methods discussed in the previous embodiments. For example, the data may be fed into an ML pipeline 1816 to create a secondary model. This secondary model is then available for subsequent rounds of self-learning, or any of the other adaptation methods discussed previously. For example, this secondary model may be leveraged in circumstances when the primary LM encounters a context with otherwise sparse real data.

These rules constitute analysis instructions 1810 and synthesis instructions 1812 that will interface with the LM to produce new semantic representations 1814 for fine-tuning. An instruction template may be used to interface with the LM, derived from the pseudocode presented above.

In one variation of this embodiment, the LM may attempt to carry out the entirety of the instructions, including the pseudocode. In another variation of this embodiment, specific control flows (e.g. conditional logic, iterating through a list) may be handled in the surrounding system by a processor that acts as a mediator, which would prompt the LM with each rule. A third variation of this embodiment would have the LM generate executable code (in a suitable programming language) from the pseudocode. A mediator would then manage the execution of that code by giving it to other components in the system capable of executing the code. In a fourth variation of this embodiment, an LM may generate more specific instructions (or a subset of instructions) from the larger, initial instruction set, for other LM agents to follow. Those skilled in the art will recognize that this approach, too, would require mediation, such as from using a multi-agent LLM framework.

It is to be understood that any of the implementations discussed herein may work in an integrated or loop fashion with any of the other implementations, where applicable. For instance, when generating labeled or annotated data from an LM, prompt augmentation can also be used to ensure LM output is congruent with the user's intentions.

Various aspects described herein may be used with any of one or more computers and/or devices each having one or more processors that may be programmed to take any of the actions described above for enhancing an LM. For example, both server and client computing systems may be implemented as one or more computers, as described above.

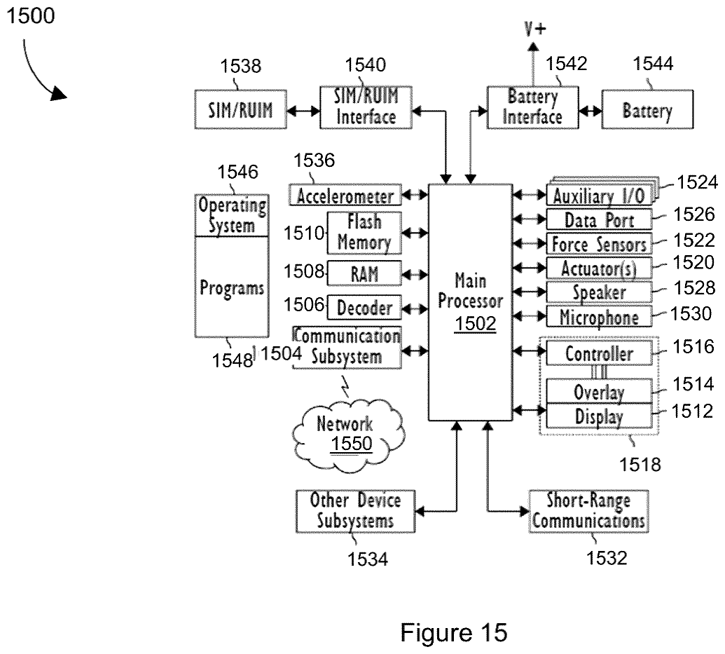

FIG. 15 shows a simplified block diagram of components of a device 1500, such as a mobile device or portable electronic device, on which various aspects of the present disclosure may be implemented. The device 1500 includes multiple components such as a processor 1502 (or processing unit) that controls the operations of the device 1500. Communication functions, including data communications, voice communications, or both may be performed through a communication subsystem 1504. Data received by the device 1500 may be decompressed and decrypted by a decoder 1506. The communication subsystem 1504 may receive messages from and send messages to a wireless network 1550.

The wireless network 1550 may be any type of wireless network, including, but not limited to, data-centric wireless networks, voice-centric wireless networks, and dual-mode networks that support both voice and data communications.

The device 1500 may be a battery-powered device and as shown includes a battery interface 1542 for receiving one or more rechargeable batteries 1544.

The processor 1502 also interacts with additional subsystems such as a Random Access Memory (RAM) 1508, a flash memory 1510, a display 1512 (e.g. with a touch-sensitive overlay 1514 connected to an electronic controller 1516 that together comprise a touch-sensitive display 1518), an actuator assembly 1520, one or more optional force sensors 1522, an auxiliary input/output (I/O) subsystem 1524, a data port 1526, a speaker 1528, a microphone 1530, short-range communications systems 1532 and other device subsystems 1534.

In some embodiments, user-interaction with the graphical user interface may be performed through the touch-sensitive overlay 1514. The processor 1502 may interact with the touch-sensitive overlay 1514 via the electronic controller 1516. Information, such as text, characters, symbols, images, icons, and other items that may be displayed or rendered on a portable electronic device generated by the processor 1502 may be displayed on the touch-sensitive display 1518.

The processor 1502 may also interact with an accelerometer 1536 as shown in FIG. 15. The accelerometer 1536 may be utilized for detecting direction of gravitational forces or gravity-induced reaction forces.

To identify a subscriber for network access according to the present embodiment, the device 1500 may use a Subscriber Identity Module or a Removable User Identity Module (SIM/RUIM) card 1538 inserted into a SIM/RUIM interface 1540 for communication with a network (such as the wireless network 1550). Alternatively, user identification information may be programmed into the flash memory 1510 or performed using other techniques.

The device 1500 also includes an operating system 1546 and software components 1548 that are executed by the processor 1502 and which may be stored in a persistent data storage device such as the flash memory 1510. Additional applications may be loaded onto the device 1500 through the wireless network 1550, the auxiliary I/O subsystem 1524, the data port 1526, the short-range communications subsystem 1532, or any other suitable device subsystem 1534.

For example, in use, a received signal such as a text message, an e-mail message, web page download, or other data may be processed by the communication subsystem 1504 and input to the processor 1502. The processor 1502 then processes the received signal for output to the display 1512 or alternatively to the auxiliary I/O subsystem 1524. A subscriber may also compose data items, such as e-mail messages, for example, which may be transmitted over the wireless network 1550 through the communication subsystem 1504.

For voice communications, the overall operation of the portable electronic device 1500 may be similar. The speaker 1528 may output audible information converted from electrical signals, and the microphone 1530 may convert audible information into electrical signals for processing.

The computer 1500 may also include storage (e.g., one or more disk drives) in addition to the memory.

The memory and/or storage may store one or more computer-executable instructions to program the processor 1502 to perform any of the functions described herein. The storage may optionally also store one or more data sets as needed. For example, a computer may in some embodiments store an AKRM data set in storage.

References herein to a computer can include any device having a programmed processor, including a rack-mounted computer, a desktop computer, a laptop computer, a tablet computer or any of numerous devices that may not generally be regarded as a computer, which include a programmed processor (e.g., a PDA, an MP3 Player, a mobile telephone, wireless headphones, etc.).

Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Examples of networks include a local area network or a wide area network, such as an enterprise network or the Internet. Such networks may be based on any suitable technology and may operate according to any suitable protocol and may include wireless networks, wired networks or fiber optic networks.

Having thus described several aspects of at least one embodiment of the present systems and methods, it is to be appreciated that various alterations, modifications, and improvements will readily occur to those skilled in the art. Such alterations, modifications, and improvements are intended to be part of this disclosure, and are intended to be within the spirit and scope of the systems and methods herein. Accordingly, the foregoing description and drawings are by way of example only.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the systems herein may be embodied as a tangible, non-transitory computer readable storage medium (or multiple computer readable storage media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer-readable storage media) encoded with one or more programs that, when executed on one or more computers or other processors, perform methods that implement the various embodiments discussed above. The computer readable medium or media can be transportable, such that the program or programs stored thereon can be loaded onto one or more different computers or other processors to implement various aspects as discussed above. As used herein, the term “non-transitory computer-readable storage medium” encompasses only a computer-readable medium that can be considered to be a manufacture (i.e., article of manufacture) or a machine.

The terms “program” or “software” are used herein in a generic sense to refer to any type of computer code or set of computer-executable instructions that can be employed to program a computer or other processor to implement various aspects as discussed above. Additionally, it should be appreciated that according to one aspect of this embodiment, one or more computer programs that when executed perform methods need not reside on a single computer or processor, but may be distributed in a modular fashion amongst a number of different computers or processors to implement various aspects.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationships between the fields. However, any suitable mechanism may be used to establish a relationship between information in fields of a data structure, including through the use of pointers, tags or other mechanisms that establish relationships between data elements.

Various aspects of the above-described embodiments may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

While the above description provides examples of one or more apparatus, methods, or systems, it will be appreciated that other apparatus, methods, or systems may be within the scope of the claims as interpreted by one of skill in the art.

1. A method for adapting a language model to represent the intentions of a user, the method comprising:
receiving, from the user, a user input including user data of a request for a language model;
analyzing the intentions of the user based on the user input and user data;
generating user-influenced data reflective of the analyzed intentions of the user;
adapting the language model based on the user-influenced data by at least one adaptation method; and
generating an output from the adapted language model.

2. The method of claim 1 wherein analyzing the intentions of the user includes an analysis of at least one of: a context; a user prompt; user preferences; and user actions.

3. The method of claim 1 wherein generating user-influenced data comprises:
receiving the user-influenced data at an input translator;
translating the user-influenced data by the input translator to a form usable by a semantic engine;
receiving the translated user-influenced data at the semantic engine;
generating a user-influenced knowledge representation representative of the translated user-influenced data by the semantic engine; and
adapting the language model based on the user-influenced knowledge representation.

4. The method of claim 1 wherein the at least one adaptation method comprises:
generating a prompt at a prompt selector from the knowledge representation; and
augmenting the prompt at a prompt injector.

5. The method of claim 1 wherein the at least one adaptation method comprises fine-tuning a machine learning model using training data derived from the user-influenced knowledge representation.

6. The method of claim 1 wherein the at least one adaptation method comprises:
deriving conditioning variables from the user-influenced knowledge representation; and
augmenting the prompt at a prompt injector by applying the conditioning variables to the prompt.

7. The method of claim 1 wherein the at least one adaptation method comprises:
deriving logical constraints from the user-influenced knowledge representation; and
applying the logical constraints in a loss function optimizer for a machine learning model.

8. The method of claim 1 further comprising evaluating a semantic coherence of the output with the analyzed intentions of the user using a semantic evaluator.

9. The method of claim 8 wherein the semantic evaluator is an atomic knowledge representation model (AKRM).

10. A device for adapting a language model to represent the intentions of a user, the device comprising:
a network interface;
a processor;
a non-transitory memory having stored thereon computer executable instructions which, when executed by the processor, configure the device to:
receive a user input including user data of a request for a language model;
analyze the intentions of the user based on the user input and user data;
generate user-influenced data reflective of the analyzed intentions of the user;
adapt the language model based on the user-influenced data by at least one adaptation method; and
generate an output from the adapted language model.

11. The device of claim 10 wherein analyzing the intentions of the user includes an analysis of at least one of: a context; a user prompt; user preferences; and user actions.

12. The device of claim 10 wherein generating user-influenced data comprises:
receiving the user-influenced data at an input translator;
translating the user-influenced data by the input translator to a form usable by a semantic engine;
receiving the translated user-influenced data at the semantic engine;
generating a user-influenced knowledge representation representative of the translated user-influenced data by the semantic engine; and
adapting the language model based on the user-influenced knowledge representation.

13. The device of claim 10 wherein the at least one adaptation method comprises:
generating a prompt at a prompt selector from the knowledge representation; and
augmenting the prompt at a prompt injector.

14. The device of claim 10 wherein the at least one adaptation method comprises fine-tuning a machine learning model using training data derived from the user-influenced knowledge representation.

15. The device of claim 10 wherein the at least one adaptation method comprises:
deriving conditioning variables from the user-influenced knowledge representation; and
augmenting the prompt at a prompt injector by applying the conditioning variables to the prompt.

16. The device of claim 10 wherein the at least one adaptation method comprises:
deriving logical constraints from the user-influenced knowledge representation; and
applying the logical constraints in a loss function optimizer for a machine learning model.

17. The device of claim 10 further comprising evaluating a semantic coherence of the output with the analyzed intentions of the user using a semantic evaluator.

18. The device of claim 17 wherein the semantic evaluator is an atomic knowledge representation model (AKRM).

19. A system for adapting a language model to represent the intentions of a user, the system comprising:
at least one processor and at least one non-transitory memory storing instructions for execution by the at least one processor to implement:
a user input device configured to provide a user input to a computing engine;
the computing engine configured to:
receive the user input including user data of a request for a language model;
analyze the intentions of the user based on the user input and user data;
generate user-influenced data reflective of the analyzed intentions of the user;
adapt the language model based on the user-influenced data by at least one adaptation method; and
generate an output from the adapted language model.

20. The system of claim 10 wherein analyzing the intentions of a user includes an analysis of at least one of: a context; a user prompt; user preferences; and user actions.

21. The system of claim 10 wherein generating user-influenced data comprises:
receiving the user-influenced data at an input translator;
translating the user-influenced data by the input translator to a form usable by a semantic engine;
receiving the translated user-influenced data at the semantic engine;
generating a user-influenced knowledge representation representative of the translated user-influenced data by the semantic engine; and
adapting the language model based on the user-influenced knowledge representation.

22. The system of claim 12 wherein the at least one adaptation method comprises:
generating a prompt at a prompt selector from the knowledge representation; and
augmenting the prompt at a prompt injector.

23. The system of claim 12 wherein the at least one adaptation method comprises fine-tuning a machine learning model using training data derived from the user-influenced knowledge representation.

24. The system of claim 12 wherein the at least one adaptation method comprises:
deriving conditioning variables from the user-influenced knowledge representation; and
augmenting the prompt at a prompt injector by applying the conditioning variables to the prompt.

25. The system of claim 12 wherein the at least one adaptation method comprises:
deriving logical constraints from the user-influenced knowledge representation; and
applying the logical constraints in a loss function optimizer for a machine learning model.

26. The system of claim 10 further comprising evaluating a semantic coherence of the output with the analyzed intentions of the user using a semantic evaluator.

27. The system of claim 15 wherein the semantic evaluator is an atomic knowledge representation model (AKRM).
